(19) United States
(12) Patent Application Publication
(10) Pub. No.: US 2012/0148806 A1
(43) Pub. Date: Jun. 14, 2012

(54) FIBERGLASS MESH SCRIM REINFORCED CEMENTITIOUS BOARD SYSTEM

(75) Inventors: Ashish DUBEY, Grayslake, IL (US); Yanfei Peng, Gurnee, IL (US)

(73) Assignee: United States Gypsum Company, Chicago, IL (US)

(21) Appl. No.: 12/965,208

(22) Filed: Dec. 10, 2010

(51) Int. Cl. E04C 2/06; B32B 13/02; B32B 37/24

(52) U.S. Cl. 428/193; 156/42; 442/1

(57) ABSTRACT

A cementitious board system which is reinforced on its opposed surfaces by an improved glass fiber mesh scrim with thicker yarn and larger mesh openings to provide a cementitious board with improved handling properties while retaining tensile strength and long term durability. The fabric is constructed as a mesh of high modulus strands of bundled glass fibers encapsulated by alkali and water resistant material, e.g. a thermoplastic material. The composite fabric also has suitable physical characteristics for embedment within the cement matrix of the panels or boards closely adjacent the opposed faces thereof. The fabric provides a board system with long-lasting, high strength tensile reinforcement and improved handling properties regardless of their spatial orientation during handling. Included as part of the invention are methods for making the reinforced board.

### FIELD OF THE INVENTION

The present invention relates generally to cementitious panels or boards, including cement board and cement fiberboard, wherein the cementitious board is reinforced for tensile strength, impact resistance and improved Runnability and field performance through use of an improved fiber mesh scrim.

### BACKGROUND OF THE INVENTION

The use of reinforced cement panels is well known in industries such as the ceramic tile industry. Generally, cement panels or boards contain a core formed of a cementitious material which may be interposed between two layers of facing material. The facing materials employed typically share the features of high strength, high modulus of elasticity, and light weight to contribute flexural and impact strength to the high compressive strength, but brittle material forming the cementitious core. Typically, the facing material employed with cement panels is fiberglass fibers or fiberglass mesh embedded in the cementitious slurry core. Fiberglass performs particularly well in this application. Fiberglass provides greater physical and mechanical properties to the cement board. Fiberglass is also an efficient material to reinforce the cement panels because of its relatively low cost compared with other high modulus materials.

Cementitious backerboard comprises a panel having a core layer of light-weight concrete with each of the two faces covered with a layer of reinforcing fabric bonded to the core layer. Such cementitious backerboards are described in U.S. Pat. No. 3,284,980 P. E. Dinkel, incorporated herein by reference in its entirety. These panels are nailable and can be readily fastened to the framing members. Furthermore they are substantially unaffected by water and consequently find extensive use in wet areas such as shower enclosures, bathtub surrounds, kitchen areas and entryways, as well as on building exteriors.

Cementitious backerboards are generally produced using a core mix of water, light-weight aggregate (e.g., expanded clay, expanded slag, expanded shale, perlite, expanded glass beads, polystyrene beads, and the like) and a cementitious material (e.g., Portland cement, magnesia cement, alumina cement, gypsum and blends of such materials). A foaming agent as well as other additives can be added to the mix.

The reinforcing fabric most generally employed is a fiber glass scrim and, in particular, is a woven mesh of vinyl coated fiber glass yarns. The yarn count per 2.54 centimeter (1 inch) of the fabric varies from 8×8 to 12×20, depending upon the size of the openings in the mesh or scrim for passage of the bonding material through the fabric. Other pervious fabrics having suitable tensile strength, alkali resistance and sufficiently large pores or openings may be employed.

Commonly the reinforcing fabric is bonded to the surface of the core layer with a thin coating of Portland cement slurry, with or without some fine aggregate added. Alternatively, the core mix can be sufficiently fluid to be vibrated or forced through the openings of the reinforcing fabric to cover the fabric and to bond it to the core layer. This is described in U.S. Pat. No. 4,450,022 of Galer, the disclosure of which is incorporated herein by reference in its entirety.

US Patent application publication number 2009/0011207, incorporated herein by reference, discloses a fast setting lightweight cementitious composition for construction of cement board or panels. The cementitious composition includes 35-60 wt. % cementitious reactive powder (also termed Portland cement-based binder), 2-10 wt. % expanded and chemically coated perlite filler, 20-40 wt. % water, entrained air, for example 10-50 vol. %, on a wet basis, entrained air, and optional additives such as water reducing agents, chemical set-accelerators, and chemical set-retarders. The lightweight cementitious compositions may also optionally contain 0-25 wt. % secondary fillers, for example 10-25 wt. % secondary fillers. Typical filler include one or more of expanded clay, shale aggregate, and pumice. The cementitious reactive powder used is typically composed of either pure Portland cement or a mixture of Portland cement and a suitable pozzolanic material such as fly ash or blast furnace slag. The cementitious reactive powder may also optionally contain one or more of gypsum (land plaster) and high alumina cement (HAC) added in small dosages to influence setting and hydration characteristics of the binder.

Other methods of manufacture of cement boards are disclosed in U.S. Pat. No. 4,203,788 to Clear, which discloses a method and apparatus for producing fabric reinforced tile backerboard panel. U.S. Pat. No. 4,488,909 to Galer et al. describes in further detail, in column 4, the cementitious composition used in a cementitious backerboard. U.S. Pat. No. 4,504,335 to Galer discloses a modified method for producing fabric reinforced cementitious backerboard. U.S. Pat. No. 4,916,004 to Ensminger et al. describes a reinforced cementitious panel in which the reinforcement wraps the edges and is embedded in the core mix. The disclosures of all of the above listed US patents are incorporated herein by reference in their entirety.

Fiberglass, however, has a major disadvantage. It lacks resistance to chemical attack from the ingredients of the cements. Common cements, such as Portland cement, provide an alkaline environment when in contact with water, and the fiberglass yarn used in reinforcement fabrics is degraded in these highly alkaline conditions. To overcome this problem, protective polymeric coatings, such as polyvinyl chloride solution coatings, are applied to the fiberglass. Although these coatings reduce fiberglass degradation, the integrity of the protective coating on the fiberglass yarns is critical to the success of the concrete panel. Furthermore, the coating rapidly degrades with heat, which typically occurs during the curing of the cementitious boards. Therefore, excess fiberglass must be included to ensure a minimum amount of strength over the life of the cement boards.

Efforts have been made to reinforce wall board through use of fabric reinforcement secured in position to the surface of the board with an adhesive as in U.S. Pat. No. 1,747,339 A to Walper, incorporated herein by reference. In Walper the fabric reinforced wall board is also coated with water-proof or moisture resistant material to protect the edges of the board against moisture.

U.S. Pat. No. 6,187,409 B1 to Mathieu, incorporated herein by reference discloses cementitious panel is reinforced with a fabric at its surface and the longitudinal edges are reinforced with a network of fibers. A continuous band of synthetic alkali-resistant, non-woven fabric completely covers the edge areas of the board with a U-shaped reinforcing mesh to make the edges resistant to impact.

US published application US2004/0219845 to Graham, incorporated herein by reference, proposed to use a carbon fiber fabric to form a scrim that wraps the board and its edges and is bonded to the board surface with an adhesive. Polyvinyl alcohol, acrylic, polyvinyl acetate, polyvinyl chloride, polyvinylidene chloride, polyacrylate, acrylic latex or styrene butadiene rubber, plastisol are disclosed as adhesives.

U.S. Pat. No. 6,054,205 to Newman et al. and related U.S. Pat. No. 6,391,131 to Newman et al, incorporated herein by reference, disclose glass fiber facing sheets comprising an open mesh glass scrim having a plurality of intersecting continuous multifilament yarns. The multifilament yarns are bonded at their crossover points to form a dimensionally stable scrim which can be used to make a cement board with facing sheets mechanically integrated into opposed surface portions of a cementitious core. A conventional method for making the glass fiber facing sheet and a method of making a cement board with this glass facing sheet is disclosed in the related U.S. Pat. No. 6,391,131.

U.S. Pat. No. 7,045,474 to Cooper et al. proposed using composite fabric for reinforcement, particularly tensile reinforcement of cementitious boards. In particular it discloses mesh constructed from fabric of high modulus strands made from bundles of glass fibers encapsulated by alkali and water resistant thermoplastic material for embedment within the cement matrix to improve tensile strength and impact resistance of the cement board. The reinforcement fabric is disclosed as a woven knit, nonwoven or laid scrim open mesh fabric having mesh openings of a size suitable to permit interfacing between the skin and core cementitious matrix material. In a preferred construction, the fabric is in a grid-like configuration having a strand count of between about 2 to about 18 strands per inch in the length and width directions. The mesh is preferably composite yarns or rovings of an elastic core strands such as E-glass fibers or similar glass fibers sheathed in a continuous coating of water and alkali resistant material including, sheathed in material.

U.S. Pat. No. 7,354,876 and U.S. Pat. No. 7,615,504 to Porter et al propose a reinforced cementitious board and methods for making the reinforced board. The reinforced board comprises a cementitious core and a reinforcing fabric embedded into at least a portion of the core on at least one surface of the core. The reinforcing fabric is not in the form of a fiberglass mesh. The reinforcing fabric includes a specific construction including a plurality of warp yarns having a first twist (turns/inch), a plurality of weft yarns having a second twist greater than the first twist, and a resinous coating applied to the fabric in a coating weight distribution of less than about 2.0:1 based upon the weight of the coating on the weft yarns over the weight of the resin on the warp yarns.

One commercially woven fiberglass mesh is available from Bayex under the number 0040/286. BAYEX 0040/286 is a Leno weave mesh having a warp and weft of 6 per inch (ASTM D-3775), a weight of 4.5 ounces per square yard (ASTM D-3776), a thickness of 0.016 inches (ASTM D-1777) and a minimum tensile of 150 and 200 pounds per inch in the warp and weft, respectively (ASTM D-5035). It is alkali resistant and has a firm hand. Other fiberglass meshes having approximately the same dimensions have opening of sufficient size to allow a portion of the gypsum/fiber mix to pass through the mesh during formation of the board may be used.

Another commercially available woven fiberglass mesh is available from Bayex under the number 0038/503. BAYEX 0038/503 is a Leno weave mesh having a warp of 6 per inch and weft of 5 per inch (ASTM D-3775), a weight of 4.2 ounces per square yard (ASTM D-3776), a thickness of 0.016 inches (ASTM D-1777) and a minimum tensile of 150 and 165 pounds per inch in the warp and weft, respectively (ASTM D-5035). It is alkali resistant and has a firm hand.

Another woven fiberglass mesh available from BAYEX under the number 0038/504. BAYEX 0038/504 is a Leno weave mesh having a warp of 6 per inch and weft of 5 per inch (ASTM D-3775), a weight of 4.2 ounces per square yard (ASTM D-3776), a thickness of 0.016 inches (ASTM D-1777) and a minimum tensile of 150 and 165 pounds per inch in the warp and weft, respectively (ASTM D-5035). It is alkali resistant and has a firm hand. Other fiberglass meshes having approximately the same dimensions have opening of sufficient size to allow a portion of the gypsum/fiber slurry to pass through the mesh during formation of the board may be used.

Yet another woven fiberglass mesh is available from BAYEX under the number 4447/252. BAYEX 4447/252 is a Leno weave mesh having a warp of 2.6 per inch and weft of 2.6 per inch (ASTM D-3775), a weight of 4.6 ounces per square yard (ASTM D-3776), a thickness of 0.026 inches (ASTM D-1777) and a minimum tensile of 150 and 174 pounds per inch in the warp and weft, respectively (ASTM D-5035). It is alkali resistant and has a firm hand. Other fiberglass meshes having approximately the same dimensions have opening of sufficient size to allow a portion of the gypsum/fiber mix to pass through the mesh during formation of the board may be used.

There remains a need for an improved cementitious panel, e.g. a cement board reinforced with reinforcing fabric scrim or non-woven fabric layers which provides for more penetration of the cement slurry through the fabric scrim during manufacture of the cement board. There also remains a need for a cement board with improved runnability and field performance (e.g. score and snap).

### SUMMARY OF THE INVENTION

The present invention relates to a new and improved cementitious panel, such as cement board, reinforced to have improved Runnability and field performance. The improved mesh made from fiberglass such as E-glass, and coated with water resistant and alkali resistant coating. The fiberglass yarn is thicker and has higher density than conventional fiberglass yarn fabric and has larger mesh grid openings between the fiber. This allows easier passage of cementitious slurry through the grid openings for more uniform coverage of the slurry layer over the embedded mesh and yet provides improved long term durability of the resulting mesh scrim reinforced cementitious board.

The cementitious panel includes a core layer made of a cement composition and an improved reinforcing fiberglass mesh or scrim on the opposing surfaces of the cement core to be embedded on or slightly into the cementitious core. The fiberglass mesh or scrim is treated with an alkali resistant coating such as a polyvinyl chloride thermal melt coating to resist degradation under alkaline conditions.

As in the case of typical cement boards, the bottom scrim or mesh layer can be extended over the panel edge and overlap at least a portion of the top mesh or scrim to which it is adhesively attached.

As commonly used in the cementitious panel art, the term “scrim” means a fabric having an open construction used as a base fabric or a reinforcing fabric. In weaving, the warp is the set of longitudinal or lengthwise yarns through which the weft is woven. Each individual warp thread in a fabric is called a warp end. In weaving, weft or woof is the yarn which is drawn through the warp yarns to create a fabric. In North America, it is sometimes referred to as the “fill” or the “filling yarn”. Thus, the weft yarn is lateral or transverse relative to the warp yarn. In a triaxial scrim, plural weft yarns having both an upward diagonal slope and a downward diagonal slope are located between plural longitudinal warp yarns located on top of the weft yarns and below the weft yarns.

Other features and advantages of the present invention will be apparent to those skilled in the art from the Detailed Description of the Preferred Embodiments presented below and accompanied by the drawings.

### BRIEF DESCRIPTION OF THE DRAWING

FIG. 1 is a perspective view of a cement panel with a scrim layer embedded in the core on the top side of the cement core and, optionally embedded on the opposed side of the core, in accordance with an embodiment of the present invention.

FIG. 2 is a diagrammatic side view of an example of a continuous manufacturing line for producing a cementitious board of the invention using an improved fiberglass mesh scrim fabric.

FIG. 3 is a bar graph of the scrim embedment depth with 5 seconds of vibration for the lab panels made in Example 2.

FIG. 4 is a bar graph of the results of the dry nail pull strength tests for the plant scale trials of the invention in Example 4.

FIG. 5 is a bar graph of the wet nail pull strength for the plant scale trials of the invention in Example 4.

FIG. 6 is a bar graph of the scrim bond strength for the plant scale trials of the invention in Example 4.

FIG. 7 is a diagram of a plain woven weave pattern of a fiberglass mesh scrim for use in the making a reinforced cementitious board of the present invention.

FIG. 8 is a diagram of a non-woven construction pattern for a fiberglass mesh scrim for use in making a reinforced cementitious board of the present invention.

### DETAILED DESCRIPTION OF THE PREFERRED EMBODIMENTS

The present invention is a new and improved cement panel reinforced on one or more of its surfaces with an embedded layer of an improved fiberglass mesh scrim material.

Cementitious Composition

TABLE 1 describes mixtures used to form the lightweight cementitious compositions of the present invention. The volume occupied by the chemically coated perlite is in the range of 7.5 to 40% and the volume occupied by the entrained air is in the range of 10 to 50% of the overall volume of the composition. This significantly assists in producing cement products having the desired low density of about 40 to 100 pcf, more preferably about 50 to 80 pounds per cubic foot.

TABLE 1
Lightweight Cementitious Compositions

| Ingredient | Weight % | Volume % |
|---|---|---|
| Portland cement-based binder | 25-60 | 10-25 |
| (cementitious reactive powder) | | |
| Chemically coated perlite | 1-10 | 4-40 |
| Expanded clay and shale aggregate | 0-25 | 0-15 |
| Water | 10-40 | 10-40 |
| Entrained Air | — | 10-50 |

The cementitious composition preferably includes: cementitious reactive powder comprising Portland cement and optionally a pozzolanic material (25-60% wt) and expanded and chemically coated perlite filler (1-10% wt), entrained air (10-50% of the composite volume, the % of composite volume being the volume % of the slurry on a wet basis),

water (10-40% wt),

optional additives such as water reducing agents, accelerators, retarders, and optional secondary fillers (10-25% wt), for example expanded clay, shale aggregate and pumice;
wherein the total of expanded and chemically coated perlite filler and secondary fillers, for example expanded clay, shale aggregate and/or pumice, is broadly 1 to 70 wt %, but typically at least 20% wt.

A typical cementitious reactive powder included 100 parts Portland cement; 30 parts fly ash; 3 parts land plaster;

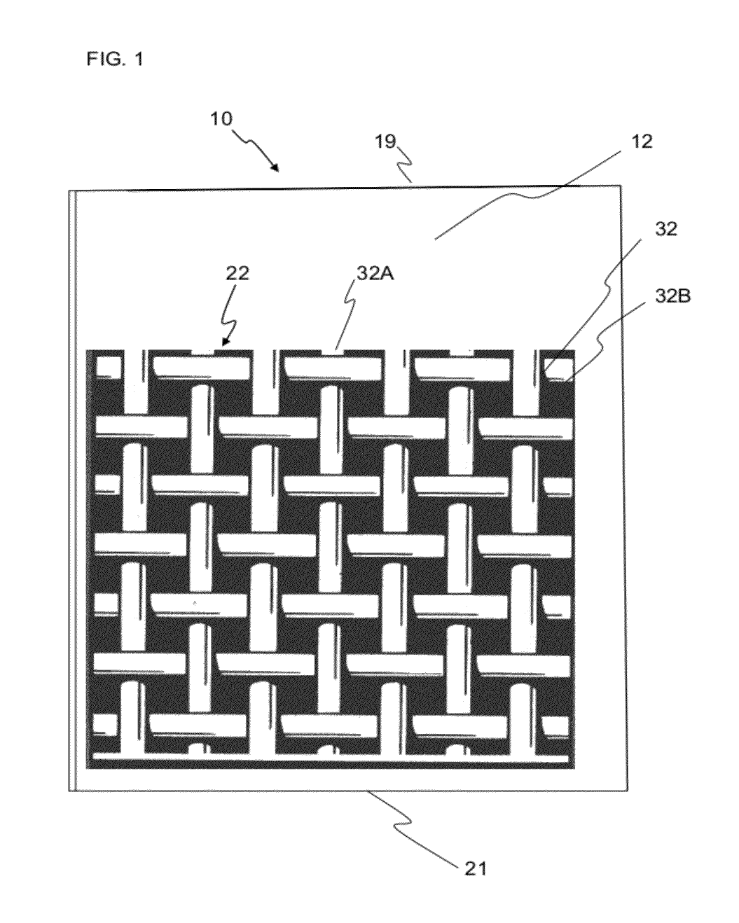

FIG. 1 schematically shows a perspective view of a cement board 10 having a cement core 12 and scrim wrapped about the core 12. The core layer 12 is made of a cement composition. The reinforcing fiberglass mesh or scrim 32 is embedded in the surface layer of the panel and can be wrapped about the core 12 to form a front layer and a back layer (not shown). The scrim 32 has warp (lengthwise or longitudinal) yarns 32A and weft (lateral or transverse) 32B yarns. The scrim or mesh layer 32 is commonly extended to its edge 21 over the panel edge 19 and overlaps at least a portion of the mesh or scrim 32 on the opposed side and is embedded in the cement core 12. The edges 21 of the core layer 12, and end portions of the scrim front layer 22 and front and back layer 32 can be wrapped to produce rounded edge corners. Because of its cementitious nature, a cement board or panel may have a tendency to be relatively brittle at its edges which often serve as points of attachment for the boards.

As commonly used in the cement panel art, the term “scrim” means a fabric having an open construction used as a base fabric or a reinforcing fabric. In a triaxial scrim, plural weft yarns having both an upward diagonal slope and a downward diagonal slope are located between plural longitudinal warp yarns located on top of the weft yarns and below the weft yarns.

Cementitious boards are generally used as a substrate for ceramic tile and coatings used must be compatible with this application. ANSI specifications 118.10 and 118.12 outline product performance for Waterproofing and Crack isolation used in conjunction with ceramic tiles. Coatings meeting the tile bonding performance requirements of these ANSI specifications are regarded as suitable for this invention.

Cementitious compositions used in making the improved mesh scrim reinforced boards of the present invention can be used to make precast concrete products such as cement boards with excellent moisture durability for use in wet and dry locations in buildings. The precast concrete products such as cement boards are made under conditions which provide a rapid setting of the cementitious mixture so that the boards can be handled soon after the cementitious mixture is poured into a stationary or moving form or over a continuously moving belt.

Rapid set is achieved by preparing the slurry containing a mixture of water, a cementitious reactive powder comprising hydraulic cement, and set accelerating amounts of alkanolamine and polyphosphate at above ambient temperatures, for example at least about 90° F. (32.2° C.), more preferably at least about 100° F. (38° C.) or at least about 105° F. (41° C.) or at least about 110° F. (43° C.). Typically the slurry has an initial temperature of about 90° F. to 160° F. (32° C. to 71° C.) or about 90° F. to 135° F. (32° C. to 57° C.), most preferably about 120 to 130° F. (49 to 54° C.).

The final setting time (i.e., the time after which cement boards can be handled) of the cementitious composition as measured according to the Gilmore needle should be at most 30 minutes, preferably at most 20 minutes, more preferably at most 10 minutes or at most 5 minutes after being mixed with a suitable amount of water. A shorter setting time and higher early compressive strength helps to increase the production output and lower the product manufacturing cost. The setting time is determined in accordance with the ASTM C266 Gilmore Needle Setting Time Test for Cement Paste.

The dosage of alkanolamine in the slurry is preferably in the range of about 0.025 to 4.0 wt %, more preferably about 0.025 to 2.0 wt %, furthermore preferably about 0.025 to 1 wt. % or about 0.05 to 0.25 wt. %, and most preferably about 0.05 to 0.1 wt. % based on the cementitious reactive components of the invention. Triethanolamine is the preferred alkanolamine. However, other alkanolamines, such as monoethanolamine and diethanolamine, may be substituted for triethanolamine or used in combination with triethanolamine.

The dosage of the polyphosphate is about 0.15 to 1.5 wt. %, preferably about 0.3 to 1.0 wt. % and more preferably about 0.4 to 0.75 wt. % based on the cementitious reactive components of the invention. While the preferred phosphate is the sodium trimetaphosphate (STMP), formulations with other polyphosphates such as potassium tripolyphosphate (KTPP), sodium tripolyphosphate (STPP), tetrasodium pyrophosphate (TSPP) and tetrapotassium pyrophosphate (TKPP) also provide enhanced final setting performance and enhanced compressive strength at reduced triethanolamine levels.

As mentioned above, these weight percents are based on the weight of the reactive components (cementitious reactive powder). This will include at least a hydraulic cement, preferably portland cement, and also may include calcium aluminate cement, calcium sulfate, and a mineral additive, preferably fly ash, to form a slurry with water. Cementitious reactive powder does not include inerts such as aggregate.

A typical cementitious reactive powder includes about 40 to 80 wt % Portland cement and about 20 to 60 wt % fly ash wherein weight percent is on a dry basis, based on the sum of the portland cement and fly ash.

Another typical cementitious reactive powder includes about 40 to 80 wt % portland cement, 0 to 20 wt % calcium aluminate cement, 0 to 7 wt % calcium sulfate, 0 to 55 wt % fly ash, on a dry basis based on the sum of the portland cement, calcium aluminate cement, calcium sulfate and fly ash. Thus, the cementitious reactive powder blend of the cementitious composition may contain concentrations of mineral additives, such as pozzolanic materials, up to 55 wt % on a dry basis of the reactive powder blend. Increasing the content of mineral additives, e.g. fly ash, would help to substantially lower the cost of the product. Moreover, use of pozzolanic materials in the composition would also help to enhance the long-term durability of the product as a consequence of the pozzolanic reactions.

The reactive powder blend of the cementitious composition should be free of externally added lime. Reduced lime content would help to lower the alkalinity of the cementitious matrix and thereby increase the long-term durability of the product.

As disclosed in U.S. Pat. No. 7,670,427 of Perez-Pena, incorporated herein by reference in its entirety, there is a synergistic interaction between the polyphosphate and the alkanolamine. Adding the polyphosphate and alkanolamine has the benefits of achieving a short final set and increasing early compressive strength for compositions with reduced alkanolamine dosages as compared to compositions lacking the polyphosphate.

In addition, adding the polyphosphate improves mix fluidity contrary to other accelerators such as aluminum sulfate which may lead to premature stiffening of concrete mixtures.

Mineral additives possessing substantial, little, or no cementing properties may be included in the rapid setting composite of the invention. Mineral additives possessing pozzolanic properties, such as class C fly ash, are particularly preferred in the reactive powder blend of the invention. Aggregates and fillers may be added depending on the application of the rapid setting cementitious composition of the invention.

Other additives such as one or more of sand, aggregate, lightweight fillers, water reducing agents such as superplasticizers, set accelerating agents, set retarding agents, air-entraining agents, foaming agents, shrinkage control agents, slurry viscosity modifying agents (thickeners), coloring agents and internal curing agents, may be included as desired depending upon the processability and application of the cementitious composition of the invention.

If desired the reactive powder blend of the invention may include or exclude calcium aluminate cement (CAC) (also commonly referred to as aluminous cement or high alumina cement) and/or calcium sulfate. In another embodiment the reactive powder blend excludes high alumina cement and includes as reactive powder components only portland cement and an optional mineral additive, preferably fly ash, at least one alkanolamine, at least one phosphate, and additives.

All percentages, ratios and proportions herein are by weight, unless otherwise specified.

### Cementitious Reactive Powder

The principal ingredient of the cementitious reactive powder of the cementitious composition of the invention is hydraulic cement, preferably portland cement.

Other ingredients may include high alumina cement, calcium sulfate, and a mineral additive, preferably a pozzolan such as fly ash. Preferably, calcium aluminate cement and calcium sulfate are used in small amounts and preferably excluded, leaving only the hydraulic cement, the mineral additive, and alkanolamine and phosphate as accelerators.

When the cementitious reactive powder of the invention includes only portland cement and fly ash, the reactive powder typically contains 40-80 wt % portland cement and 20-60 wt % fly ash, based on the sum of these components.

When other ingredients are present, the cementitious reactive powder may typically contain 40-80 wt % portland cement, 0 to 20 wt % calcium aluminate cement, 0 to 7 wt % calcium sulfate, and 0 to 55 wt % fly ash based on the sum of these components.

### Hydraulic Cement

Hydraulic cements, such as portland cement, make up a substantial amount of the compositions of the invention. It is to be understood that, as used here, “hydraulic cement” does not include gypsum, which does not gain strength under water, although typically some gypsum is included in portland cement. ASTM C 150 standard specification for portland cement defines portland cement as a hydraulic cement produced by pulverizing clinker consisting essentially of hydraulic calcium silicates, usually containing one or more of the forms of calcium sulfate as an inter-ground addition. More generally, other hydraulic cements may be substituted for portland cement, for example calcium sulfo-aluminate based cements. To manufacture portland cement, an intimate mixture of limestone and clay is ignited in a kiln to form portland cement clinker. The following four main phases of portland cement are present in the clinker—tricalcium silicate (3CaO.SiO₂, also referred to as C₃S), dicalcium silicate (2CaO.SiO₂, called C₂S), tricalcium aluminate (3CaO.Al₂O₃ or C₃A), and tetracalcium aluminoferrite (4CaO.Al₂O₃.Fe₂O₃ or C₄AF). The resulting clinker containing the above compounds is inter-ground with calcium sulfates to desired fineness to produce the portland cement.

The other compounds present in minor amounts in portland cement include double salts of alkaline sulfates, calcium oxide, and magnesium oxide. When cement boards are to be made, the portland cement will typically be in the form of very fine particles such that the particle surface area is greater than 4,000 cm²/gram and typically between 5,000 to 6,000 cm²/gram as measured by the Blaine surface area method (ASTM C 204). Of the various recognized classes of portland cement, ASTM Type III portland cement is most preferred in the cementitious reactive powder of the cementitious compositions of the invention. This is due to its relatively faster reactivity and high early strength development.

In one embodiment of the present invention, the use of Type III portland cement is minimized and relatively fast early age strength development can be obtained using other cements instead of Type III portland cement. The other recognized types of cements which may be used to replace or supplement Type III portland cement in the composition of the invention include Type I portland cement, or other hydraulic cements including Type II portland cement, white cement, slag cements such as blast-furnace slag cement, pozzolan blended cements, expansive cements, sulfo-aluminate cements, and oil-well cements.

Mineral Additives

The hydraulic cement may be partially substituted by mineral additives possessing substantial, little, or no cementing properties. Mineral additives having pozzolanic properties, such as fly ash, are particularly preferred in the cementitious reactive powder of the invention.

ASTM C618-97 defines pozzolanic materials as “siliceous or siliceous and aluminous materials which in themselves possess little or no cementitious value, but will, in finely divided form and in the presence of moisture, chemically react with calcium hydroxide at ordinary temperatures to form compounds possessing cementitious properties.” Various natural and man-made materials have been referred to as pozzolanic materials possessing pozzolanic properties. Some examples of pozzolanic materials include pumice, perlite, diatomaceous earth, silica fume, tuff, trass, rice husk, metakaolin, ground granulated blast furnace slag, and fly ash. All of these pozzolanic materials can be used either singly or in combined form as part of the cementitious reactive powder of the invention. Fly ash is the preferred pozzolan in the cementitious reactive powder blend of the invention. Fly ashes containing high calcium oxide and calcium aluminate content (such as Class C fly ashes of ASTM C618 standard) are preferred as explained below. Other mineral additives such as calcium carbonate, vermiculite, clays, and crushed mica may also be included as mineral additives.

Fly ash is a fine powder byproduct formed from the combustion of coal. Electric power plant utility boilers burning pulverized coal produce most commercially available fly ashes. These fly ashes consist mainly of glassy spherical particles as well as residues of hematite and magnetite, char, and some crystalline phases formed during cooling. The structure, composition and properties of fly ash particles depend upon the structure and composition of the coal and the combustion processes by which fly ash is formed. ASTM C618 standard recognizes two major classes of fly ashes for use in concrete—Class C and Class F. These two classes of fly ashes are derived from different kinds of coals that are a result of differences in the coal formation processes occurring over geological time periods. Class F fly ash is normally produced from burning anthracite or bituminous coal, whereas Class C fly ash is normally produced from lignite or sub-bituminous coal.

The ASTM C618 standard differentiates Class F and Class C fly ashes primarily according to their pozzolanic properties. Accordingly, in the ASTM C618 standard, the major specification difference between the Class F fly ash and Class C fly ash is the minimum limit of SiO₂+Al₂O₃+Fe₂O₃ in the composition. The minimum limit of SiO₂+Al₂O₃+Fe₂O₃ for Class F fly ash is 70% and for Class C fly ash is 50%. Thus, Class F fly ashes are more pozzolanic than the Class C fly ashes. Although not explicitly recognized in the ASTM C618 standard, Class C fly ashes typically contain high calcium oxide content. Presence of high calcium oxide content makes Class C fly ashes possess cementitious properties leading to the formation of calcium silicate and calcium aluminate hydrates when mixed with water. As will be seen in the examples below, Class C fly ash has been found to provide superior results, particularly in the preferred formulations in which calcium aluminate cement and gypsum are not used.

The weight ratio of the pozzolanic material to the portland cement in the cementitious reactive powder blend used in the cementitious composition of the invention may be about 0/100 to 150/100, preferably 75/100 to 125/100. In some cementitious reactive powder blends the portland cement is about 40 to 80 wt % and fly ash 20 to 60 wt %.

### Calcium Aluminate Cement

Calcium aluminate cement (CAC) is another type of hydraulic cement that may form a component of the reactive powder blend of some embodiments of the invention.

Calcium aluminate cement (CAC) is also commonly referred to as aluminous cement or high alumina cement. Calcium aluminate cements have a high alumina content, about 36-42 wt % is typical. Higher purity calcium aluminate cements are also commercially available in which the alumina content can range as high as 80 wt %. These higher purity calcium aluminate cements tend to be very expensive relative to other cements. The calcium aluminate cements used in the compositions of some embodiments of the invention are finely ground to facilitate entry of the aluminates into the aqueous phase so that rapid formation of ettringite and other calcium aluminate hydrates can take place. The surface area of the calcium aluminate cement that may be used in some embodiments of the composition of the invention will be greater than 3,000 cm²/gram and typically about 4,000 to 6,000 cm²/gram as measured by the Blaine surface area method (ASTM C 204).

Several manufacturing methods have emerged to produce calcium aluminate cement worldwide. Typically, the main raw materials used in the manufacturing of calcium aluminate cement are bauxite and limestone. One manufacturing method that has been used in the US for producing calcium aluminate cement is described as follows. The bauxite ore is first crushed and dried, then ground along with limestone. The dry powder comprising of bauxite and limestone is then fed into a rotary kiln. A pulverized low-ash coal is used as fuel in the kiln. Reaction between bauxite and limestone takes place in the kiln and the molten product collects in the lower end of the kiln and pours into a trough set at the bottom. The molten clinker is quenched with water to form granulates of the clinker, which is then conveyed to a stock-pile. This granulate is then ground to the desired fineness to produce the final cement.

Several calcium aluminate compounds are formed during the manufacturing process of calcium aluminate cement. The predominant compound formed is monocalcium aluminate (CaO.Al₂O₃, also referred to as CA). The other calcium aluminate and calcium silicate compounds that are formed include 12CaO.7Al₂O₃ also referred to as C₁₂A₇, CaO.2Al₂O₃ also referred as CA₂, dicalcium silicate (2CaO.SiO₂, called C₂₋₅), dicalcium alumina silicate (2CaO.Al₂O₃.SiO₂, called C₂AS). Several other compounds containing relatively high proportion of iron oxides are also formed. These include calcium ferrites such as CaO.Fe₂O₃ or CF and 2CaO.Fe₂O₃ or C₂F, and calcium alumino-ferrites such as tetracalcium aluminoferrite (4CaO.Al₂O₃.Fe₂O₃ or C₄AF), 6CaO.Al₂O₃.2Fe₂O₃ or C₆AF₂) and 6CaO.2Al₂O₃.Fe₂O₃ or C₆A₂F). Other minor constituents present in the calcium aluminate cement include magnesia (MgO), titanic (TiO₂), sulfates and alkalis.

### Calcium Sulfate

Various forms of calcium sulfate as shown below may be used in the invention to provide sulfate ions for forming ettringite and other calcium sulfo-aluminate hydrate compounds:

Dihydrate—CaSO₄.2H₂O (commonly known as gypsum or landplaster)

Hemihydrate—CaSO₄.½H₂O (commonly known as stucco or plaster of Paris or simply plaster)

Anhydrite—CaSO₄ (also referred to as anhydrous calcium sulfate)

Landplaster is a relatively low purity gypsum and is preferred due to economic considerations, although higher purity grades of gypsum could be used. Landplaster is made from quarried gypsum and ground to relatively small particles such that the specific surface area is greater than 2,000 cm²/gram and typically about 4,000 to 6,000 cm²/gram as measured by the Blaine surface area method (ASTM C 204). The fine particles are readily dissolved and supply the gypsum needed to form ettringite. Synthetic gypsum obtained as a by-product from various manufacturing industries can also be used as a preferred calcium sulfate in the present invention. The other two forms of calcium sulfate, namely, hemihydrate and anhydrite may also be used in the present invention instead of gypsum, i.e., the dihydrate form of calcium sulfate.

Alkanolamines

Different varieties of alkanolamines can be used alone or in combination to accelerate the setting characteristics of the cementitious composition of the invention. A typical family of alkanolamine for use in the present invention is NH₃₋ₙ(ROH)ₙ wherein n is 1, 2 or 3 and R is an alkyl having 1, 2 or 3 carbon atoms. Some examples of useful alkanolamines include monoethanolamine [NH₂(CH₂—CH₂OH)], diethanolamine [NH(CH₂—CH₂OH)₂], and triethanolamine [N(CH₂—CH₂OH)₃]. Triethanolamine (TEA) is the most preferred alkanolamine in the present invention.

Alkanolamines are amino alcohols that are strongly alkaline and cation active. The alkanolamine, for example triethanolamine, is typically used at a dosage of about 0.025 to 4.0 wt %, preferably about 0.025 to 2.0 wt %, more preferably about 0.025 to 1.0% wt %, furthermore preferably about 0.05 to 0.25 wt. %, and most preferably about 0.05 to 0.1 wt. % based on the weight of the cementitious reactive powder of the invention. Thus for example, for 100 pounds cementitious reactive powder there is about 0.025 to 4.0 pounds of alkanolamine.

Addition of alkanolamines and polyphosphate (described below) has a significant influence on the rapid setting characteristics of the cementitious compositions of the invention when initiated at elevated temperatures. Addition of an appropriate dosage of alkanolamine and polyphosphate under conditions that yield slurry temperature greater than 90° F. (32° C.) permits a significant reduction of the final setting times.

Polyphosphates

While a preferred polyphosphate is sodium trimetaphosphate, formulations with other phosphates such as potassium tripolyphosphate, sodium tripolyphosphate, tetrasodium pyrophosphate and tetrapotassium pyrophosphate also provide formulations with enhanced final setting performance and enhanced compressive strength at reduced alkanolamine, e.g., triethanolamine, levels.

The dosage of polyphosphate is about 0.15 to 1.5 wt. %, preferably about 0.3 to 1.0 wt. % and more preferably about 0.5 to 0.75 wt. % based on the cementitious reactive components of the invention. Thus for example, for 100 pounds of cementitious reactive powder, there may be about 0.15 to 1.5 pounds of polyphosphate.

The degree of rapid set obtained with the addition of an appropriate dosage of polyphosphate under conditions that yield slurry temperature greater than 90° F. (32° C.) allows a significant reduction of triethanolamine in the absence of high alumina cement.

Polyphosphates or condensed phosphates employed are compounds having more than one phosphorus atom, wherein the phosphorus atoms are not bonded to each other. However, each phosphorus atom of the pair is directly bonded to at least one same oxygen atom, e.g., P—O—P. The general class of condensed phosphates in the present application includes metaphosphates, and pyrophosphates. The polyphosphate employed is typically selected from alkali metal polyphosphates.

Metaphosphates are polyphosphates which are cyclic structures including the ionic moiety ((PO₃)ₙ)ⁿ⁻, wherein n is at least 3, e.g., (Na₃(PO₃)₃). Ultraphosphates are polyphosphates in which at least some of the PO₄ tetrahedra share 3 corner oxygen atoms. Pyrophosphates are polyphosphates having an ion of (P₂O₇)⁴⁻, e.g., Naₙ H₄₋ₙ (P₂O₇) wherein n is 0 to 4.

Set Retarders

Use of set retarders as a component in the compositions of the invention is particularly helpful in situations where the initial slurry temperatures used to form the cement-based products are particularly high, typically greater than 100° F. (38° C.). At such relatively high initial slurry temperatures, retarders such as sodium citrate or citric acid promote synergistic physical and chemical reaction between different reactive components in the compositions resulting in favorable slurry temperature rise response and rapid setting behavior. Without the addition of retarders, stiffening of the reactive powder blend of the invention may occur very rapidly, soon after water is added to the mixture. Rapid stiffening of the mixture, also referred to as “false setting” is undesirable, since it interferes with the proper and complete formation of ettringite, hinders the normal formation of calcium silicate hydrates at later stages, and leads to development of extremely poor and weak microstructure of the hardened cementitious mortar.

The primary function of a retarder in the composition is to keep the slurry mixture from stiffening too rapidly thereby promoting synergistic physical interaction and chemical reaction between the different reactive components. Other secondary benefits derived from the addition of retarder in the composition include reduction in the amount of superplasticizer and/or water required to achieve a slurry mixture of workable consistency. All of the aforementioned benefits are achieved due to suppression of false setting. Examples of some useful set retarders include sodium citrate, citric acid, potassium tartrate, sodium tartrate, and the like. In the compositions of the invention, sodium citrate is the preferred set retarder. Furthermore, since set retarders prevent the slurry mixture from stiffening too rapidly, their addition plays an important role and is instrumental in the formation of good edges during the cement board manufacturing process. The weight ratio of the set retarder to the cementitious reactive powder blend generally is less than 1.0 wt %, preferably about 0.04-0.3 wt %.

Secondary Inorganic Set Accelerators

As discussed above, alkanolamines in combination with polyphosphates are primarily responsible for imparting extremely rapid setting characteristics to the cementitious mixtures. However, in combination with the alkanolamines and polyphosphates, other inorganic set accelerators may be added as secondary inorganic set accelerators in the cementitious composition of the invention.

Addition of these secondary inorganic set accelerators is expected to impart only a small reduction in setting time in comparison to the reduction achieved due to the addition of the combination of alkanolamines and polyphosphates. Examples of such secondary inorganic set accelerators include a sodium carbonate, potassium carbonate, calcium nitrate, calcium nitrite, calcium formate, calcium acetate, calcium chloride, lithium carbonate, lithium nitrate, lithium nitrite, aluminum sulfate and the like. The use of calcium chloride should be avoided when corrosion of cement board fasteners is of concern. The weight ratio of the secondary inorganic set accelerator to the cementitious reactive powder blend typically will be less than 2 wt %, preferably about 0.1 to 1 wt %. In other words for 100 pounds of cementitious reactive powder there is typically less than 2 pounds, preferably about 0.1 to 1 pound, of secondary inorganic set accelerator. These secondary inorganic set accelerators can be used alone or in combination.

Other Chemical Additives and Ingredients

Chemical additives such as water reducing agents (superplasticizers) may be included in the compositions of the invention. They may be added in the dry form or in the form of a solution. Superplasticizers help to reduce the water demand of the mixture. Examples of superplasticizers include polynapthalene sulfonates, polyacrylates, polycarboxylates, lignosulfonates, melamine sulfonates, and the like. Depending upon the type of superplasticizer used, the weight ratio of the superplasticizer (on dry powder basis) to the reactive powder blend typically will be about 2 wt. % or less, preferably about 0.1 to 1.0 wt. %.

When it is desired to produce lightweight products such as lightweight cement boards; air-entraining agents (or foaming agents) may be added in the composition to lighten the product.

Air entraining agents are added to the cementitious slurry to form air bubbles (foam) in situ. Air entraining agents are typically surfactants used to purposely trap microscopic air bubbles in the concrete. Alternatively, air entraining agents are employed to externally produce foam which is introduced into the mixtures of the compositions of the invention during the mixing operation to reduce the density of the product. Typically to externally produce foam the air entraining agent (also known as a liquid foaming agent), air and water are mixed to form foam in a suitable foam generating apparatus and then the foam is added to the cementitious slurry.

Examples of air entraining/foaming agents include alkyl sulfonates, alkylbenzolfulfonates and alkyl ether sulfate oligomers among others. Details of the general formula for these foaming agents can be found in U.S. Pat. No. 5,643,510.

An air entraining agent (foaming agent) such as that conforming to standards as set forth in ASTM C 260 “Standard Specification for Air-Entraining Admixtures for Concrete” (Aug. 1, 2006) can be employed. Such air entraining agents are well known to those skilled in the art and are described in the Kosmatka et al. “Design and Control of Concrete Mixtures,” Fourteenth Edition, Portland Cement Association, specifically Chapter 8 entitled, “Air Entrained Concrete,” (cited in US Patent Application Publication No. 2007/0079733 A1). Commercially available air entraining materials include vinsol wood resins, sulfonated hydrocarbons, fatty and resinous acids, aliphatic substituted aryl sulfonates, such as sulfonated lignin salts and numerous other interfacially active materials which normally take the form of anionic or nonionic surface active agents, sodium abietate, saturated or unsaturated fatty acids and salts thereof, tensides, alkyl-aryl-sulfonates, phenol ethoxylates, lignosulfonates, resin soaps, sodium hydroxystearate, lauryl sulfate, ABSs (alkylbenzenesulfonates), LASs (linear alkylbenzenesulfonates), alkanesulfonates, polyoxyethylene alkyl(phenyl)ethers, polyoxyethylene alkyl(phenyl)ether sulfate esters or salts thereof, polyoxyethylene alkyl(phenyl)ether phosphate esters or salts thereof, proteinic materials, alkenylsulfosuccinates, alpha-olefinsulfonates, a sodium salt of alpha olefin sulphonate, or sodium lauryl sulphate or sulphonate and mixtures thereof.

Typically the air entraining (foaming) agent is about 0.01 to 1 wt. % of the weight of the overall cementitious composition.

Other chemical admixtures such as shrinkage control agents, coloring agents, viscosity modifying agents (thickeners) and internal curing agents may also be added in the composition of the cement panel of the invention.

Aggregates and Fillers

While the disclosed cementitious reactive powder blend defines the rapid setting component of the cementitious composition of the invention, it will be understood by those skilled in the art that other materials may be included in the composition depending on its intended use and application.

For instance, for cement board applications, it is desirable to produce lightweight boards without unduly compromising the desired mechanical properties of the product. This objective is achieved by adding lightweight aggregates and fillers. Examples of useful lightweight aggregates and fillers include blast furnace slag, volcanic tuff, pumice, sand, expanded forms of clay, shale, and expanded perlite, hollow ceramic spheres, hollow plastic spheres, expanded plastic beads, and the like. For producing cement boards, expanded clay and shale aggregates are particularly useful. Expanded plastic beads and hollow plastic spheres when used in the composition are required in very small quantity on weight basis owing to their extremely low bulk density.

Depending on the choice of lightweight aggregate or filler selected, the weight ratio of the lightweight aggregate or filler to the reactive powder blend may be about 1/100 to 200/100, preferably about 2/100 to 125/100. For example, for making lightweight cement boards, the weight ratio of the lightweight aggregate or filler to the reactive powder blend preferably will be about 2/100 to 125/100. In applications where the lightweight product feature is not a critical criterion, river sand and coarse aggregate as normally used in concrete construction may be utilized as part of the composition of the invention.

Scrims

Discrete reinforcing fibers of different types may also be included in the cementitious compositions of the invention. Scrims made of materials such as polymer-coated glass fibers and polymeric materials. Cement boards, produced according to the present invention, are typically reinforced with scrims made of polymer-coated glass fibers.

There are currently two common commercial processes for making fiberglass mesh scrims for cementitious board products, namely the woven and non-woven processes.

In the woven process, the yarns made from the glass fibers are first coated with an alkali-resistant polymer. The alkali resistant polymer for coating woven or nonwoven yarns can be selected from polyvinyl chloride, polyvinyl alcohol, polyvinyl acetate, wax, polyester, acrylics, acrylonitrile, silicones, styrene-butadiene, polypropylene, and polyethylene. The yarns are then weaved to form a mesh, and bonded together with applied heat.

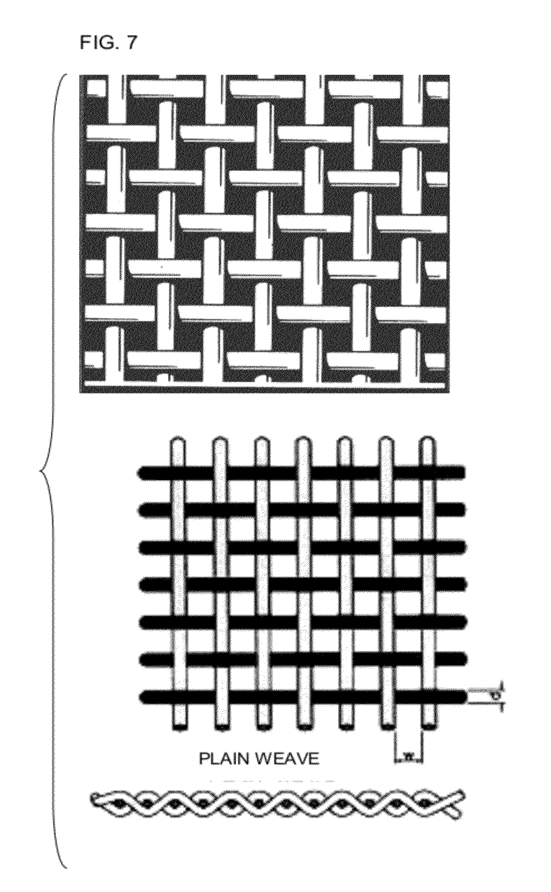

There are different weaving patterns, with the most commonly used pattern being the plain weave, in which the warp (longitudinal) and weft (transverse) are aligned so they form a simple criss-cross pattern. Each weft thread crosses the warp threads by going over one, then under the next, and so on. The next weft thread goes under the warp threads that it neighbors went over, and vice-versa. A diagram of a typical plain weave is shown in FIG. 7.

Descriptions of the woven process can be found in “Production of backing Fabrics-Woven”, by G.A. Build, Don Brothers, Buist & Co. Ltd., and Low Brothers & Co. (Dundee) Ltd, Carpet Substrates, edited by Dr. Peter Ellis, pp 31-44, The Textile Trade Press, 1973. Another reference to the woven process can be found in “Textiles”, 4^{th} edition, by Norma Hollen and Jane Saddler, MacMillan Publishing Co., Inc. 1973.

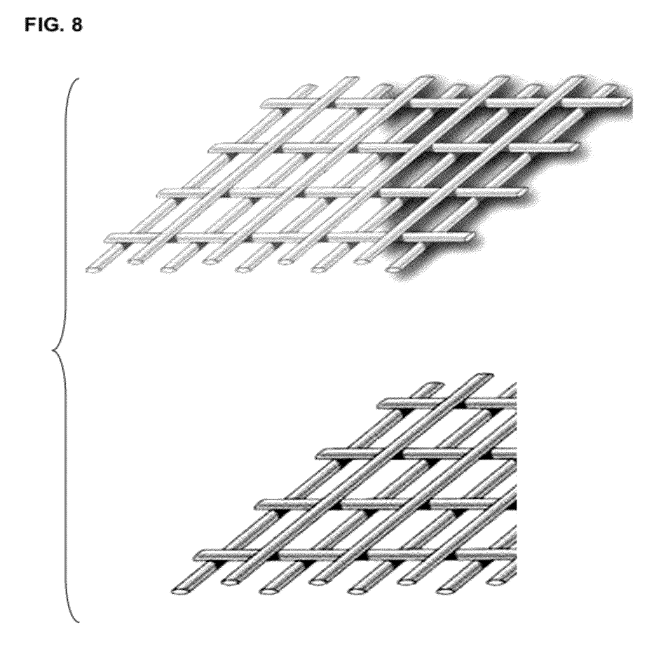

In the non-woven process, there are no separate stages for coating and overlaying and attaching the yarn. The raw fiberglass yarns are overlayed, and are then transported through a coating bath, where the mesh picks up the coating. The coating then cures and bonds the yarns to form a mesh. The most common scrim construction of a non-woven mesh scrim is shown in FIG. 8. The first warp thread under a weft thread is followed by a warp thread above the weft thread. This pattern is repeated across the whole width. Two threads will always meet at the intersections.

In the present invention, conventional fiberglass mesh scrims are replaced with new mesh scrims which are made from fiberglass strands made in the form of yarns or rovings which are constructed into mesh from bundles of fiberglass strands. The fiberglass strands are made from E-glass which have typical physical properties listed in Table 2 below. Table 3 lists properties of the fiber glass yarns which are used to make both conventional mesh scrim, such as the G75 yarn commercially available from PPG Industries (Pittsburgh, Pa.), AGY Holdings Corp. (Aiken, S.C.), and Saint Gobain Vetrotex America (Hunterville, N.C.) mesh scrim, and the improved mesh scrim used in making the cement board products of the present invention, such as the G-50 and G-37 yarns also available from PPG, AGY, and Saint Gobain Vetrotex are used to make the improved mesh scrim of the invention. The mesh scrim used in the present invention can be made from the improved fiberglass yarn into mesh having less strands per inch in both the longitudinal (machine) and transverse (cross machine) directions for a mesh with about 4×4 to 6×6, preferably in the range of 4×4 to 5×5 strands per inch, e.g. 4×5 or 4.5×5. This results in a mesh with a larger mesh grid opening than was considered useful by one skilled in the art. This produces a reinforced cement board with improved processability, long term durability, field performance and more uniform distribution of the mesh on the surfaces of the cement board or which is embedded in the cementitious slurry before drying of the formed cement board.

The improved fiberglass mesh used in the present invention are made from thicker fiberglass yarn such as the DE 37, DE 50, G-50, G-37, H 12, H 25, H 55 and K 18 fiberglass yarns manufactured by PPG, AGY, and Vetrotex, and coated with alkali resistant coating. The filaments designations DE, G, H and K used by the textile industry are listed in Table 4. The different yarn can be mixed and the mesh opening can be non-uniform. The coatings are typically selected from wax, polyvinyl chloride (PVC), polyvinyl alcohol (PVA), polyvinyl acetate (PVAc), polyester, acrylics, acrylonitrile, silane, silicones, styrene-butadiene, polypropylene, polyethylene and epoxy.

Typically the fiberglass yarn in an uncoated state has a nominal density of 1200 to 5000 linear yards per pound of uncoated fiberglass yarn. The coated fibers are typically 40-65 wt. % alkali resistant coating on a dry basis with the remainder being the glass fiber itself.

TABLE 2
Mechanical Properties of E-Glass

| Tensile strength (psi/GPa) | 2-3 × 10⁵/1.4-2.0 |
|---|---|
| Modulus of elasticity tension (psi/GPa) | 10.5 × 10⁶/72.4 |
| Poisson's ratio | 0.22 |
| Creep | None |
| Elongation (%) Standard (at break) | 3-4 |
| Elastic recovery (%) | 100 |

TABLE 3
Mechanical Properties of Glass Yarn

| | Yardage | | | |
|---|---|---|---|---|
| | Bare glass, | With binder, | | Minimum |
| | nominal density | nominal density | | tensile |
| Yarn | (linear yards per | (linear yards per | TEX | strength |
| type | pound) | pound) | values | (lbs) |
| DE37 | 3700 | 3682 | 134 | 12.0 |
| DE50 | 5000 | 4978 | 99 | 9.5 |
| G37 | 3700 | 3660 | 134 | 14.7 |
| G50 | 5000 | 4946 | 99 | 9.5 |
| G75 | 7300 | 7221 | 66 | 7.6 |
| H12 | 1215 | 1205 | 413 | 36.7 |
| H25 | 2500 | 2475 | 198 | 19.5 |
| H55 | 5500 | 5432 | 90 | 9.5 |
| K18 | 1800 | 1781 | 275 | 24.0 |

TABLE 4
Textiles Fibers Designation

| Filament | Filament | | |
|---|---|---|---|
| designation | designation SI | Diameter in | Diameter in |
| US units | units | Inches | micrometers |
| DE | 6.0 | 0.00025 | 6.35 |
| G | 9.0 | 0.00036 | 9.14 |
| H | 11.0 | 0.00043 | 10.92 |
| K | 13.0 | 0.00053 | 13.46 |

The yarn used for making the warp and welt can have 0.7Z-3.0Z twists per inch. The tex values of the yarns used for the G37 is 134 and 99 for the G50 compared to 66 for the G75.

Enhanced and improved impact resistance of the cement board is provided by embedding a reinforcing mesh in both the top surface and the bottom surface of the board. The mesh may be either woven or non-woven and may be made of a variety of materials, for example, fiberglass, polyester, or polypropylene. Preferably the mesh is made from a flat yarn of a low elasticity material such as fiberglass mesh. Most preferably the mesh is a fiber glass mesh having openings in the mesh of sufficient size to allow a quantity of the slurry to pass through the mesh and embed the mesh in set cement in the final product.

It is preferred to have the mesh substantially embedded in the board and covered by the cementitious mix, because this secures the mesh to the board. Additionally, completely embedding the mesh in the cementitious mix provides the best impact resistance to the board. Completely embedding the mesh in the cementitious mix also makes the reinforcement less perceptible to the consumer and improves overall surface properties.

The improved mesh scrim of the present invention is designed to meet the following technical requirements:

1. The initial tensile strength should not be less than 80 lbs/in in both directions.
2. The scrim should have no less than 4 ends or more than 14 ends per linear inch in both directions. Scrims with too many ends are more difficult to embed in the slurry, and those with too few ends may have unacceptable dimensional stability.
3. The coating material should provide excellent alkali resistance to high pH normally seen in concrete, and resistance to other fiberglass deteriorating mechanisms prevalent in concrete. One inch of scrim sample should retain 70% of the original strength after 3 hour exposure in 1% NaOH solution at room temperature.

Initial Slurry Temperature

In the present invention, forming the slurry under conditions which provide an initially high slurry temperature was found to be important to achieve rapid setting and hardening of cementitious formulations. The initial slurry temperature should be at least about 90° F. (32° C.). Slurry temperatures in the range of 90° F. to 160° F. (32° C. to 71° C.) or 90° F. to 135° F. (32° C. to 57° C.) produce very short setting times. The initial slurry temperature is preferably about 120° F. to 130° F. (49° to 54° C.).

In general, within this range increasing the initial temperature of the slurry increases the rate of temperature rise as the reactions proceed and reduces the setting time. Thus, an initial slurry temperature of 95° F. (35° C.) is preferred over an initial slurry temperature of 90° F. (32° C.), a temperature of 100° F. (38° C.) is preferred over 95° F. (35° C.), a temperature of 105° F. (41° C.) is preferred over 100° F. (38° C.), a temperature of 110° F. (43° C.) is preferred over 105° F. (41° C.) and so on. It is believed the benefits of increasing the initial slurry temperature decrease as the upper end of the broad temperature range is approached.

As will be understood by those skilled in the art, achieving an initial slurry temperature may be accomplished by more than one method. Perhaps the most convenient method is to heat one or more of the components of the slurry. In the examples, the present inventors supplied water heated to a temperature such that, when added to the dry reactive powders and unreactive solids, the resulting slurry is at the desired temperature. Alternatively, if desired the solids could be provided at above ambient temperatures. Using steam to provide heat to the slurry is another possible method that could be adopted.

Although potentially slower, a slurry could be prepared at ambient temperatures, and promptly (e.g., within about 10, 5, 2 or 1 minutes) heated to raise the temperature to about 90° F. or higher (or any of the other above-listed ranges), and still achieve benefits of the present invention.

### Manufacturing of Precast Concrete Products Such as Cement Boards

Precast concrete products such as cement boards are manufactured most efficiently in a continuous process in which the reactive powder blend is blended with aggregates, fillers and other necessary ingredients, followed by addition of water and other chemical additives just prior to placing the mixture in a mold or over a continuous casting and forming belt.

Due to the rapid setting characteristics of the cementitious mixture it should be appreciated that the mixing of dry components of the cementitious blend with water usually will be done just prior to the casting operation. As a consequence of the formation of hydrates of calcium aluminate compounds and the associated water consumption in substantial quantities the cement-based product becomes rigid, ready to be cut, handled and stacked for further curing.

The conventional commercial production standards for cement board, like DUROCK brand cement board made by USG Corporation, uses between 4×4 and 14×14 ends per linear inch. Due to the need for long term durability of the mesh scrim in an alkali environment in the cement board, the scrim must be coated with an alkali resistant coating, such as polyvinyl chloride polymer, to coat the glass fibers bundle. The coating must be free of cracks and holes which impair performance.

The scrim with the thicker yarn G-50 or G-37 yarns have strength similar to the conventional mesh scrim since it has 50% more or double the number of filaments compared to the conventional G75 yarn at the same mesh dimensions of 5×5 to 8×8. The polymer coating is typically applied in a two step coating, with a coating applied in the first bath to penetrate between filaments, and the balance of the amount of coating which is conventionally applied to the G75 yarn being applied in the second coating bath to encapsulate the bundle.

The improved Runnability, long term durability and field performance of a cementitious board made with the improved fiberglass mesh scrim of the invention is illustrated in the following examples.

Board Manufacturing

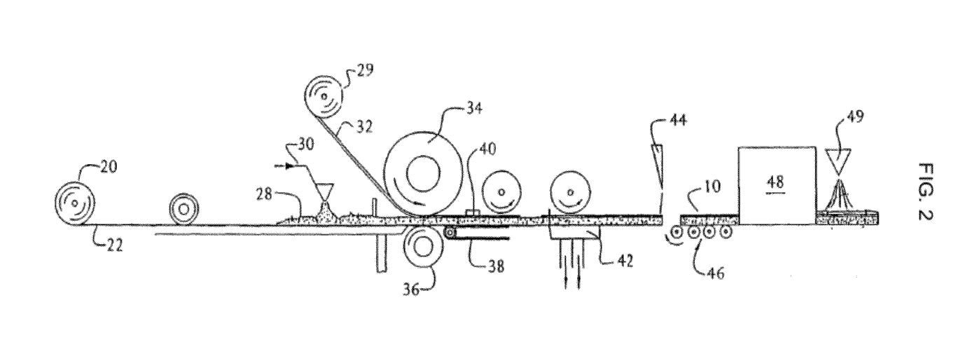

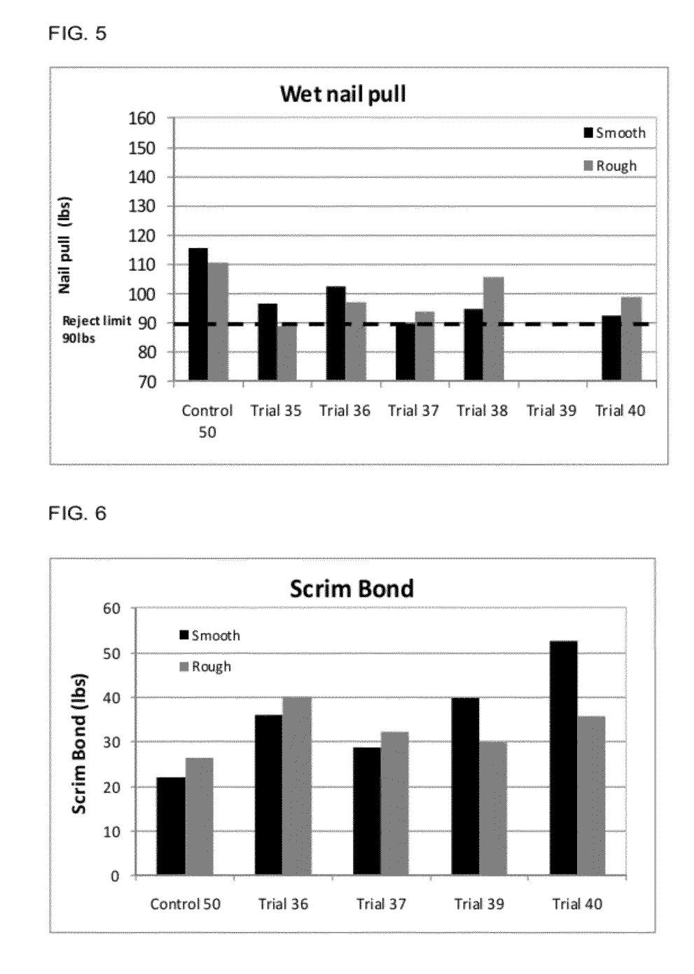

Although a number of acceptable commercial cement board manufacturing procedures may be used in accordance with the practice of this invention, including the procedures set forth in FIGS. 5 and 6 of the previously referenced U.S. Pat. No. 6,391,131B1 of Newman et al, an acceptable method of continuously manufacturing cementitious boards is described in U.S. Pat. No. 7,354,876 of St. Gobain with reference to FIG. 2.

Cementitious boards 10 can be manufactured in any number of ways, including molding, extrusion, and semi-continuous processes employing rollers and segments of the fabric 22 of this invention. The cementitious board 10 includes a set cementitious core 12 (see FIG. 1), made of set Portland cement, for example. The cementitious core 12 preferably comprises a cementitious material, such as cement paste, mortar or concrete, and/or other types of materials such as gypsum and geopolymers (inorganic resins). More preferably the inorganic matrix comprises Portland cement having chopped fibers dispersed throughout the cement. Preferably the fibers are AR-glass fibers but may also include, for example, other types of glass fibers, aramides, polyolefins, carbon, graphite, polyester, PVA, polypropylene, natural fibers, cellulosic fibers, rayon, straw, paper and hybrids thereof. The inorganic matrix may include other ingredients or additives such as fly ash, latex, slag and metakaolin, resins, such as acrylics, polyvinyl acetate, or the like, ceramics, including silicon oxide, titanium oxide, and silicon nitrite, setting accelerators, water and/or fire resistant additives, such as siloxane, borax, fillers, setting retardants, dispersing agents, dyes and colorants, light stabilizers and heat stabilizers, shrinkage reducing admixtures, air entraining agents, setting accelerators, foaming agents, or combinations thereof, for example. In a preferred embodiment, the inorganic matrix includes a resin that may form an adhesive bond with a resinous coating applied to the alkali-resistant open fibrous layer. Preferably the cementitious core 12 has good bonding with the coated fiberglass mesh facings 22 and 32. The cementitious core 12 may contain curing agents or other additives such as coloring agents, light stabilizers and heat stabilizers.

Examples of materials which have been reported as being effective for improving the water-resistant properties of cementitious products either as a binder, finish or added coating, or performance additive 103 are the following: poly(vinyl alcohol), with or without a minor amount of poly(vinyl acetate); metallic resinates; wax or asphalt or mixtures thereof; a mixture of wax and/or asphalt and also corn-flower and potassium permanganate; water insoluble thermoplastic organic materials such as petroleum and natural asphalt, coal tar, and thermoplastic synthetic resins such as poly(vinyl acetate), polyvinylchloride and a copolymer of vinyl acetate and vinyl chloride and acrylic resins; a mixture of metal rosin soap, a water soluble alkaline earth metal salt, and residual fuel oil; a mixture of petroleum wax in the form of an emulsion and either residual fuel oil, pine tar or coal tar; a mixture comprising residual fuel oil and rosin, aromatic isocyanates and disocyanates; organohydrogenpolysiloxanes and other silicones, acrylics, and a wax-asphalt emulsion with or without such materials as potassium sulfate, alkali and alkaline earth eliminates. Performance additives 103 can be introduced directly into the cementitious slurry 28. The added coating can be applied to the fabric before and/or after joining to the cementitious core 12.

Continuous Manufacturing Method

An attractive feature of the present invention is that the cementitious board 10 can be made utilizing existing cement board manufacturing lines, for example, as shown somewhat diagrammatically in FIG. 2. In conventional fashion, dry ingredients (not shown) from which the cementitious core 12 is formed are pre-mixed and then fed to a mixer of the type commonly referred to as a mixer 30. Water and other liquid constituents (not shown) used in making the core are metered into the mixer 30 where they are combined with the dry ingredients to form an aqueous cementitious slurry 28. Foam is generally added to the slurry in the mixer 30 to control the density of the resulting cementitious core 12.

A sheet of top coated fiberglass fabric 32 is fed from the top glass fabric roll 29 onto the top of the cementitious slurry 28, thereby sandwiching the slurry between the two moving fabrics which form the facings of the cementitious core 12 which is formed from the cementitious slurry 28. The bottom and top glass fabrics 22 and 32, with the cementitious slurry 28 sandwiched therebetween enter the nip between the upper and lower forming or shaping rolls 34 and 36 and are thereafter received on a conveyer belt 38.

Conventional wallboard edge guiding devices 40 shape and maintain the edges of the composite until the slurry has set sufficiently to retain its shape. Sequential lengths of the board are cut by a water knife 44. The cementitious board 10 is next moved along feeder rolls 46 to permit it to set. An additional sprayer 49 can be provided to add further treatments, such as silicone oil, additional coating, or fire retardants, to the exterior of the board.

The cement board of the present invention which is made with the improved scrim is designed to meet the following technical requirements:

1. The flexural strength shall not be less than 750 psi (5170 KPa) when tested in accordance with ASTM C947.

2. The minimum saturated nail-head pull through resistance is 90 lb (400 N) when tested according to ASTM D1037.

3. The shear bond strength must demonstrate a minimum shear bond strength at 7 day curing of 50 psi (345 KPa) when tested in accordance with ANSI A118.1, A118.4 and A136.1.

4. Score and snap: single score is needed for the new scrim, compared to the two scores are needed for the current prior art scrim.

5. Good scrim bond to the matrix and resistance to delamination is needed. This ensures proper load transfer from the matrix to the mesh after matrix cracks. Also, there will be less flaking on the back side when scored and snapped. The scrim bond is greater for the trial mesh on both sides.

6. Ease of mesh embedment: the mesh needs to be embedded with a certain depth to have a good scrim bond. Usually when the mesh opening is small, it is more difficult for the slurry to penetrate the scrim and have a proper mesh embedment depth. It has been found in plant scale production, it is easier to embed the mesh of the present invention compared to conventional mesh scrim, especially for the top mesh scrim.

### Example 1

Specific examples of typical cement boards made with a fiberglass mesh scrim made with a conventional G-75 fiberglass yarn available from the St-Gobain Technical Fabrics, which has a yarn fiber density of about 7500 linear yards per one pound of yarn and has a typical mesh grid structure with 8 to 7.5 strands per inch in the longitudinal (machine) and transverse (cross machine) directions compare to an improved fiberglass mesh scrim which is made from a G-37 fiberglass yarn which has also been made by St-Gobain technical Fabrics, which is made from a similarly water and alkali resistant coated fiberglass fabric and mesh constructed but which is thicker in diameter and which has a density of about 3700 linear yards per one pound of fiberglass yarn and which is made into a mesh with 4 to 5 strands per inch e.g. 4.5×4.5 strands per inch, in the longitudinal (machine) and transverse (cross machine) directions, as shown in Table 5, below.

TABLE 5-As-is and Long Term Flexural Strength of panel made with the formulation of TABLE 10, after 14 days of Accelerated Aging. Fiber glass Mesh Scrim.

| | | | Longitudinal | | Transverse | |
|---|---|---|---|---|---|---|
| | | Number | (Machine) | MD | (Cross Machine) | XMD |
| Fiber glass | | of data | Direction (MD) | DMAX | direction (XMD) | DMAX |
| Mesh Scrim | | points | MOR(psi) | (in.) | MOR(psi) | (In.) |
| G-75 Mesh | As-Is | 1903 | 1240 ± 104 | 0.739 ± 0.081 | 1159 ± 114 | 0.786 ± 0.086 |
| Scrim 8 × 7.5 | | | | | | |
| strands per inch | | | | | | |
| G-75 Mesh | 14 d LTD | 118 | 547 | 0.285 | 515 | 0.260 |
| Scrim 8 × 7.5 | | | | | | |
| strands per inch | | | | | | |
| G-37 Mesh | As-Is | 1 | 1104 | 0.768 | 1216 | 1.053 |
| Scrim 4.5 × 4.5 | | | | | | |
| strands per inch | | | | | | |
| G-37 Mesh | 14 d LTD | 1 | 880 | 0.709 | 627 | 0.407 |
| Scrim 4.5 × 4.5 | | | | | | |
| strands per inch. | | | | | | |

The above evaluation of the conventional and new mesh scrim shows better long term durability (LTD) performance than the conventional mesh scrim in terms of flexural strength. The modulus of rupture (MOR) and the maximum deflection at failure (DMAX) is determined by 4-point bending test with a 10 inch span length. Four-point bending tests were conducted according to the ASTM C 947 test method. The specimens were tested at 10″ span (254 mm). The testing was performed on a close-loop MTS testing system. The load was applied at a constant displacement rate of 0.171 minute (2.54 mm/1 minute). The following flexural properties were calculated according to the ASTM C 947 and ASTM C 1325 test methods for the various boards investigated: The 14 day LTD results were obtained by testing the MOR after 14 days of accelerated aging in 80° C. water. The “as-is” performance for the conventional mesh scrim is based upon manufacturing plant data observed during a two year period from 2007 to 2009. The new mesh scrim has a similar “as-is” performance to the conventional mesh scrim but it shows superior long-term durability performance, especially in the lateral (machine) direction.

Several samples of a lab DUROCK® brand cement board, of the general formulation shown in TABLE 6-2, below, which are available from USG Corporation of Chicago, Ill. 60661, were prepared using a conventional G-75 fiberglass yarn and a G37 fiberglass yarn mesh scrim of the present invention. Both scrims were made by Saint Gobain Technical Fibers of Albion, N.Y.

The mechanical properties and process characteristics of DUROCK® Brand cement board made with St. Gobain G-37 4×4 scrim and conventional 8×8 St Gobain G-75 scrim are summarized in Table 6.

TABLE 6

| Item | Property/Characteristic | Test | Result | Note |
|---|---|---|---|---|
| 1 | Scrim embedment | See test | Easier to | Panel density |
| | | below | embed | 52-57 pcf. |
| 2 | Maximum aggregate | | May also use | |
| | size | | 9.5 mm to 0 | |

Scrim Embedment

Lab panels were made and the embedment depth was measured for the bottom side only. The mesh was loosely laying on the bottom when the slurry was poured in. The panel was vibrated for 5 seconds to mimic the vibrating table at the plants. A desired target embedment depth of 0.03-0.06 inch has been shown to provide good flexural strength and no scrim peeled off when scored.

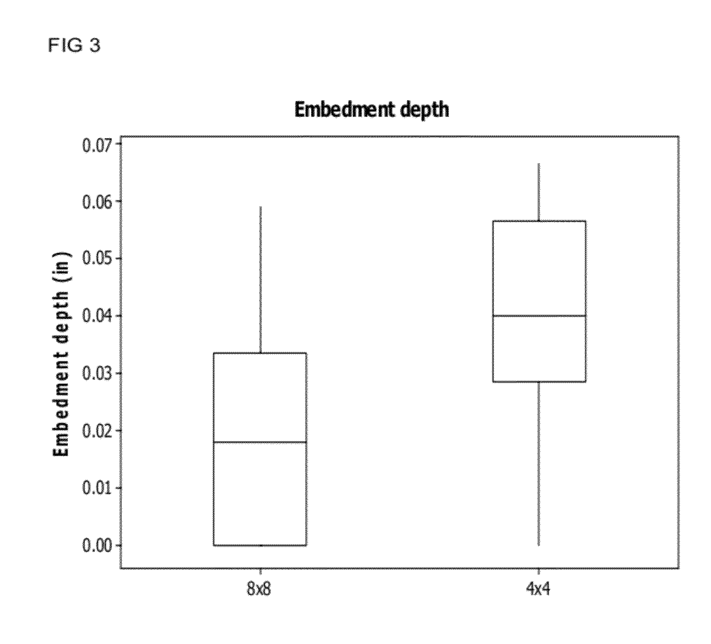

The results shown in FIG. 3 confirm a better scrim embedment for the 4×4 scrim compared to the 8×8 conventional control mesh scrim.

Maximum Aggregate Size

The more open 4×4 mesh is expected to allow for a bigger maximum size for the aggregate. Currently the aggregate is close to the fine aggregate (4.75 mm to 0) according to ASTM C330. It is possible that the combined fine and coarse aggregate (9.5 mm to 0) can also be used with the 4×4 mesh.

### Example 3

A number of lab test panels were made from the formulations of TABLE 10 and TABLE 11 (see Example 4) in a mold with the bottom scrim laid in first, followed by pouring the cementitious slurry and then removing excess slurry with a trowel to give a thickness of 0.5″. The top scrim is then placed over the top of the slurry and then the surface is gently finished with a trowel to make sure the top scrim is embedded into the slurry. The samples are sealed and cured at 90° F./90% RH for 7 days before the flexural strength and nail pull testing is performed. The slurry formulation used for the lab cast is the same formulation in manufacturing cement panels is used at the plants to evaluate the effect of the use of a wide range of panel density on the nail pull strength obtained with the 4×4 fiberglass mesh scrim of the invention.

The manufactured cement boards were skin-reinforced using alkali-resistant, polyvinyl chloride (PVC) coated fiberglass mesh embedded in cementitious slurry. The reinforcing mesh was manufactured by Saint-Gobain Technical Fabrics.

The composition included in the example was combined using a weight ratio of water to cement (cementitious reactive powder) of 0.60:1 and a weight ratio of expanded shale aggregate to cementitious reactive powder ratio of 0.35:1. The dry reactive powder ingredients, perlite, and aggregate used were mixed with water under conditions which provided an initial slurry temperature above ambient. Hot water was used having a temperature which produced slurry having an initial temperature within the range of 125° to 140° F. (51.7° to 60.0° C.).

The dosage rates of various chemical additives (triethanolamine, sodium citrate, sodium trimetaphosphate and naphthalene sulfonate superplasticizer) were adjusted to achieve desired flow behavior and rapid-setting characteristics

The manufactured cement boards were hard and could be handled within 10 minutes subsequent to slurry preparation and board formation.

Mechanical testing was conducted to characterize the physical properties of the manufactured lightweight cement boards.

Flexural strength was measured according to the testing per ASTM C 947.

Maximum deflection was measured using the flexural load versus deflection plot obtained for a specimen tested in flexure per ASTM C 947. Maximum deflection represents the displacement of the specimen at the middle-third loading points corresponding to the peak load.

Nail pull strength was measure according to the testing per ASTM D1037.

Two days after manufacture, the boards were tested for characterization of flexural performance per ASTM C947. TABLE 7 and 8 show the flexural performance of tested boards in both the lateral (machine) and transverse (cross-machine) directions for Tables 5 and 6, respectively. Results shown in the table demonstrate the panels developed excellent flexural strength and flexural ductility.

TABLE 7
Flexural performance of cement boards made using the conventional
cementitious composition of TABLE 10 of Example 1 with
the improved mesh scrim of the invention.

| Sample | Flexural | Maximum Deflection |
|---|---|---|
| Orientation | Strength (psi) | (inches) |
| Longitudinal or | 1058 | 0.990 |
| Machine Direction | | |
| Transverse or | 1137 | 1.218 |
| Cross-Machine | | |
| Direction | | |

TABLE 8
Flexural performance of cement boards of the present invention
made using the lightweight cementitious composition of TABLE
11 of Example 1 and the improved mesh scrim.

| Sample | Flexural | Maximum Deflection |
|---|---|---|
| Orientation | Strength (psi) | (inches) |
| Longitudinal or | 1262 | 0.99 |
| Machine Direction | | |
| Transverse or | 1138 | 0.94 |
| Cross-Machine | | |
| Direction | | |

The data shown in TABLE 9 demonstrates satisfactory nail pull performance of the panels of the invention.

TABLE 9
Nail pull performance of cement boards made using
the conventional composition of Table 10 and
the improved 4 × 4 scrim of the invention.

| Sample Orientation | Nail Pull Strength (lbs.) |
|---|---|
| Face-Up | 156 |
| Face-Down | 136 |

TABLE 9 shows the nail pull performance of the manufactured panels. The panels were tested for nail pull strength in accordance with Test Method ASTM C-1325-08B “Standard Specification for Non-Asbestos Fiber-Mat Reinforced Cementitious Backer Units” and ASTM D 1037-06a “Standard Test Methods for Evaluating Properties of Wood-Base Fiber and Particle Panel Materials” utilizing a roofing nail with a 0.375 in. (10 mm) diameter head and a shank diameter of 0.121 in. (3 mm). Wet nail pull, the samples were soaked in water for 24 hours at room temperature before testing.

### Example 4

### Plant Scale Production of Cement Board Made with 4×4 Fiberglass Mesh Scrim of the Present Invention Compared to Cement Board Made with Conventional 8×8 Fiberglass Mesh Scrim

Since use of more open mesh like the G-37 mesh scrim for the tighter mesh of the conventional G-75 mesh scrim could present a potential problem for nail pull performance, this property was tested on the following plant trial samples of cement board in this Example.

The following examples illustrates producing lightweight cement boards in a commercial manufacturing process using the improved fiberglass mesh scrim of the invention. The raw materials used included a cementitious reactive powder of Portland cement Type III, class C fly ash, and calcium sulfate dihydrate (landplaster), chemically coated perlite, expanded clay and shale aggregate and added liquids. The liquids, e.g., triethanolamine, were admixtures added as aqueous solutions. In addition, sodium citrate and sulfonated napthalene superplasticizer were added to control the fluidity of the mixes. These admixtures were added as weight percentage of the total reactive powder.

TABLE 10 shows a composition of a conventional cement board used to produce 0.5 inch thick cement panels with the improved scrim of the present invention having a density of about 60 pounds per cubic foot (pcf) (1.0 g/cc), for comparison as a control 78 pounds per cubic foot (pcf) (1.25 g/cc)

TABLE 10
Example of conventional cementitious composition of the slurry
for a conventional mesh scrim reinforced cement board system.

| Ingredient | Weight % | Volume % |
|---|---|---|
| Portland cement-based binder | 43 | 18 |
| (cementitious reactive powder)¹ | | |
| Expanded clay and shale aggregate | 35 | 29 |
| Total Liquids² | 22 | 27 |
| Entrained air | | 26 |

¹Portland Cement—100 parts by weight; Fly Ash 30 parts by weight; Land Plaster—3 parts by weight
²Total liquids is a combination of water plus the following chemical additives added to water to form a solution:
Polyphosphate—0.20 wt. % based on weight of Portland cement-based binder
Triethanolamine—0.20 wt. % based on weight of Portland cement-based binder
Naphthalene Sulfonate based superplasticizer—0.30 wt. % based on weight of Portland cement-based binder
Sodium Citrate—0.20 wt. % based on weight of Portland cement-based binder
³Entrained Air in the composite provided by using sodium alpha olefin sulfonate (AOS) surfactant. The surfactant was added at a dosage rate of 0.009 wt. % of the total product weight.

TABLE 11 shows a specific composition of a preferred cement board system used to produce 0.5 inch (1.27 cm) thick lightweight cement panels made with the improved mesh scrim of the present invention having a density of about 60 pounds per cubic foot (pcf) (1.0 g/cc).

The manufactured cement boards were skin-reinforced using alkali-resistant, polyvinyl chloride (PVC) coated fiberglass mesh embedded in cementitious slurry. The reinforcing mesh was manufactured by Saint-Gobain Technical Fabrics.

TABLE 11
Example of preferred lightweight cementitious composition
of the slurry for the cement board system of the invention.

| Ingredient | Weight % | Volume % |
|---|---|---|
| Portland cement-based binder | 47.8 | 14.4 |
| (cementitious reactive powder)¹ | | |
| Chemically coated expanded perlite | 4.8 | 17.2 |
| Expanded clay and shale aggregate | 21.5 | 12.9 |
| Total Liquids² | 25.8 | 23.1 |
| Entrained Air³ | — | 32.5 |

¹Portland Cement—100 parts by weight; Fly Ash 30 parts by weight; Land Plaster—3 parts by weight
²Total liquids is a combination of water plus the following chemical additives added to water to form a solution:
Polyphosphate—0.20 wt. % based on weight of Portland cement-based binder
Triethanolamine—0.20 wt. % based on weight of Portland cement-based binder
Naphthalene Sulfonate based superplasticizer—0.30 wt. % based on weight of Portland cement-based binder
Sodium Citrate—0.20 wt. % based on weight of Portland cement-based binder
³Entrained Air in the composite provided by using sodium alpha olefin sulfonate (AOS) surfactant. The surfactant was added at a dosage rate of 0.009 wt. % of the total product weight.

The chemically coated perlite was SILBRICO brand perlite, model SIL-CELL 35-23 having a median particle diameter of 40 microns and an alkyl alkoxy silane coating.

Entrained air in the board was introduced by means of surfactant foam that was prepared separately and added directly to the wet cementitious slurry in the slurry mixer. Sodium alpha olefin sulfonate (AOS) surfactant in a water-based solution was used to prepare the foam. The surfactant concentration in the water-based solution was 0.90 wt %. It should be noted that a combination of entrained air, perlite, and expanded clay aggregate in the composition was responsible for achieving the targeted low slurry density.

The manufactured cement boards were skin-reinforced using alkali-resistant, polyvinyl chloride (PVC) coated fiberglass mesh embedded in cementitious slurry. The reinforcing mesh was manufactured by Saint-Gobain

### Technical Fabrics.

The composition included in the example was combined using a weight ratio of water to cement (cementitious reactive powder) of 0.60:1 and a weight ratio of expanded shale aggregate to cementitious reactive powder ratio of 0.35:1. The dry reactive powder ingredients, perlite, and aggregate used were mixed with water under conditions which provided an initial slurry temperature above ambient. Hot water was used having a temperature which produced slurry having an initial temperature within the range of 125° to 140° F. (51.7° to 60.0° C.).

The dosage rates of various chemical-additives (triethanolamine, sodium citrate, sodium trimetaphosphate and naphthalene sulfonate superplasticizer) were adjusted to achieve desired flow behavior and rapid-setting characteristics.

The manufactured cement boards were hard and could be handled within 10 minutes subsequent to slurry preparation and board formation.

Mechanical testing was conducted to characterize the physical properties of the manufactured lightweight cement boards.

Flexural strength was measured according to the testing per ASTM C 947.

Maximum deflection was measured using the flexural load versus deflection plot obtained for a specimen tested in flexure per ASTM C 947. Maximum deflection represents the displacement of the specimen at the middle-third loading points corresponding to the peak load.

Nail pull strength was measure according to the testing per ASTM D1037.

Two days after manufacture, the boards were tested for characterization of flexural performance per ASTM C947. TABLES 7 and 8 show the flexural performance of tested boards in both the lateral (machine) and transverse (cross-machine) directions for Tables 5 and 6, respectively. Results shown in the table demonstrate the panels developed excellent flexural strength and flexural ductility.

TABLE 12 shows the nail pull performance of the manufactured panels. The panels were tested for nail pull strength in accordance with Test Method ASTM C-1325-08B “Standard Specification for Non-Asbestos Fiber-Mat Reinforced Cementitious Backer Units” and ASTM D 1037-06a “Standard Test Methods for Evaluating Properties of Wood-Base Fiber and Particle Panel Materials” utilizing a roofing nail with a 0.375 in. (10 mm) diameter head and a shank diameter of 0.121 in. (3 mm). Wet nail pull, the samples were soaked in water for 24 hours at room temperature before testing.

The data shown in TABLE 12 demonstrates satisfactory nail pull performance of the panels of the invention.

TABLE 12
Nail pull performance of cement boards made using the 4 ×
4 scrim and the lightweight composition of TABLE 11.

| Sample Orientation | Nail Pull Strength (lbs.) |
|---|---|
| Face-Up | 113 |
| Face-Down | 119 |

Production plant scale trial panels, numbered Trial #37 through Trial #40, were prepared with the 4×4 fiberglass mesh scrim of the invention, supplied by St. Gobain, and a control panel #50, made with a conventional

8×8 fiberglass mesh scrim, also supplied by St. Gobain, using the cement composition of the invention of TABLE 11 under commercial plant manufacturing procedure, with the bottom layer of mesh scrim being first laid down, then the cementitious slurry is discharged onto the bottom mesh and then a top layer of mesh scrim is placed on top of the cementitious slurry. The slurry has the same composition as the slurry formulation used in the laboratory prepared samples shown in TABLE 11.

Trials #39 and #40 were made with higher target board weight of 62 pcf compared to the target board weight of 60 pcf for the panels of Trials 37 to 38 and Control #50 to evaluate the effect of increased board weight on nail pull strength of the board.

Runnability

The plant trial runs showed that it is easier to run the 4×4 mesh of the invention compared to the conventional mesh scrim if the control. It was found that it was easier to embed the top mesh into the slurry due to its more open structure. The more open mesh structure also allowed the use of more viscous slurry. Slurries containing greater maximum aggregate size can also be used.

Score and Snap

It is a common practice in the field to cut the panels during installation. A utility knife is used to score the top surface of the cementitious panels a couple of times and then snap the panel into two pieces. Since the bottom mesh is usually still bridging the two pieces, the bottom mesh must also be cut.

In evaluating score and snap, the panel is evaluated for ease of scoring the surface, which has been found to relate to the number of strands in the mesh scrim. While it usually takes two scores with a panel made with the current mesh scrim, panels made with the mesh scrim of the invention require only one score. Moreover, while it has been found in the field that there is a chance that the cement covering on the bottom scrim will flake or delaminate, there was less flaking with the mesh scrim of the invention, due to the greater scrim bond for the panels made with the scrim of the invention.

In evaluating score and snap, the panel is evaluated for ease of scoring the surface, which has been found to relate to the number of strands in the mesh scrim. While it usually takes two scores with a panel made with the current mesh scrim, panels made with the mesh scrim of the invention require only one score. Moreover, while it has been found in the field that there is a chance that the cement covering on the bottom scrim will flake or delaminate, there was less flaking with the mesh scrim of the invention, due to the greater scrim bond for the panels made with the scrim of the invention.

Edge Fastening

The test panel is fastened to a wood stud with fastener close to the edges (cut edge and regular edge). The integrity of the panel at the point where the fastener is positioned, i.e., whether the panel holds together or blows out when fastened close to the edge. No difference in panel integrity was observed between the panels made with the conventional mesh and the mesh of the invention.

Scrim Bond

The bond strength between the mesh and core of a cement board is measured by the force required to debond the scrim from a 6″ wide core. Adequate bond strength ensures proper load transfer from the cement matrix to the scrim and satisfactory flexural performance. It is also desired in installation in the field to avoid delamination or flaking during scoring and snapping, or sawing.

The results for testing of scrim bond strength for the mesh scrim of the invention is shown in the bar graph in FIG. 6. The trial boards made with the 4×4 scrim have higher bond results then the control boards made with the 8×8 scrim.

The detailed results of process and field evaluation of the plant trial with cement boards system of the present invention made with the cement composition of TABLE 11 and a 4×4 scrim compared to a 8×8 mesh scrim obtained from St. Gobain are set forth in TABLE 13.

TABLE 13

| | Control regular 8 × 8 | |
|---|---|---|
| | scrim | Trial 4 × 4 scrim |
| Runnability | Good | Excellent, no process |
| | | issue, top mesh easier to |
| | | embed |
| Score and | Good | Excellent, less scores (1 |
| snap | (2 scores with no | score versus 2 scores |
| | dangling scrim on the | for the control) with no |
| | cut edge) | dangling scrim on the cut |
| | | edge. Less flaking |
| | | observed on the back |
| | | side of the panel |
| | | compared to control |
| | | scrim. |

| | |
|---|---|
| Surface | No difference |
| appearance | |
| Edge | No difference |
| appearance | |
| Mesh | No difference |
| embedment | |
| Edge | No difference |
| fastening | |

The tests of mechanical properties of the plant scale panels were performed in accordance with ASTM C947-03 (Reapproved 2009) “Standard Test Method for Flexural Properties of Thin-Section Glass-Fiber Reinforced Concrete, using simple beam with Third-Point Loading

This test evaluates the long-term durability of cement board. Glass scrim, used as reinforcement in cement board, degrades in the alkaline environment in cement board. This is also true for polymer coated glass scrim, because there is always imperfection in the coating that makes the glass susceptible to the attack.

The long-term durability test uses an accelerated aging procedure to predict the long-term performance of coated glass in cement boards. The board samples are soaked in 80° C. water for a specific time, tested for flexural strength, and compared with the initial flexural performance. One day at 80° C. equals approximately 1.1 year of normal aging.

As shown in Table 14, the Flexural test for the “as-is” for trials #37 and #39, and the 7, 14 28 and 42 day long term flexural performance of trials #37 of the 4×4 mesh of the invention is comparable to conventional 8×8 mesh of the control (Trial #50).

TABLE 14
Flexural performance

| | |
|---|---|
| MD | XMD |

| | | | MOR | DMAX | MOR | DMAX |
|---|---|---|---|---|---|---|
| | | | (psi) | (in) | (psi) | (in) |
| Control | As-is | | 1007 | 1.096 | 1073 | 0.872 |
| #50 | 7 | d LTD | 559 | 0.350 | 673 | 0.560 |
| | 14 | d LTD | 434 | 0.240 | 531 | 0.350 |
| | 28 | d LTD | 427 | 0.240 | 335 | 0.140 |
| | 42 | d LTD | 314 | 0.180 | 278 | 0.110 |
| Trial | As-is | | 1030 | 1.246 | 965 | 0.906 |
| #37 | 7 | d LTD | 673 | 0.560 | 611 | 0.560 |
| | 14 | d LTD | 545 | 0.400 | 420 | 0.240 |
| | 28 | d LTD | 339 | 0.120 | 313 | 0.110 |
| | 42 | d LTD | 300 | 0.110 | 290 | 0.110 |

| | | | | | |
|---|---|---|---|---|---|
| Trial | As-is | 1087 | 0.950 | 973 | 0.972 |
| #39 | | | | | |

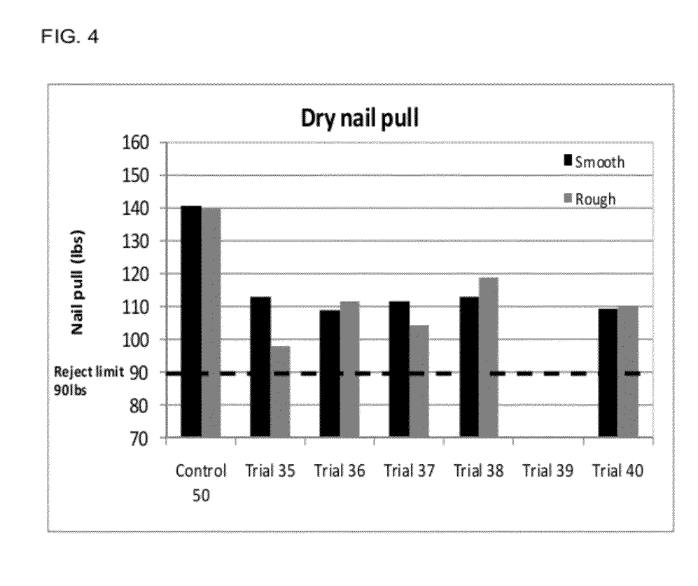

The dry and wet nail pull strength of all of the trial samples, shown in the bar graphs of FIGS. 4 and 5, show that the trial panels with the improved mesh meet the nail pull specifications per ASTM C1325 and ANSI 118.9.

The results of the plant scale test demonstrate the very important improvement in bond of the scrim to the core of the panel to avoid delamination of the scrim from the core during installation when the conventional score and snap installation procedure is used. The scrim on each side of the panel is much easier to score than previous commercial scrim and leaves a cleaner cut and less flaking on the back side of the panel.

### Example 5

Cement boards of the formulation of TABLE 11 were prepared and tested in accordance with the method in Example 4, above, using a 4×4 per square inch construction scrim made with G37 yarn, supplied by Phifer Incorporated. The scrim reinforced cement board provided satisfactory as-is and long term performance as shown in TABLE 15.

TABLE 15
Flexural performance

| | |
|---|---|
| MD | XMD |

| | MOR | DMAX | MOR | DMAX |
|---|---|---|---|---|
| | (psi) | (in) | (psi) | (in) |
| As-is | 1020 | 0.915 | 990 | 0.970 |
| 7 d LTD | 634 | 0.563 | 695 | 0.705 |
| 14 d LTD | 525 | 0.442 | 621 | 0.486 |

### Comparative Example

Two additional comparative test samples were made with the compositions shown in TABLES 16 and 17, below:

TABLE 16
Comparative Formulation C
TABLE 16

| Ingredient | Weight % | Volume % |
|---|---|---|
| Portland cement-based binder | 48.3 | 20.3 |
| (cementitious reactive powder)¹ | | |
| Expanded clay and shale | 16.9 | 13.8 |
| aggregate | | |
| Chemically coated expanded | 5.8 | 29.3 |
| perlite | | |
| Total Liquids² | 29.0 | 36.3 |

¹Portland Cement—100 parts by weight; Fly Ash 30 parts by weight; Land Plaster—3 parts by weight
²Total liquids is a combination of water plus the following chemical additives added to water to form a solution:
Polyphosphate—0.20 wt. % based on weight of Portland cement-based binder
Triethanolamine—0.30 wt. % based on weight of Portland cement-based binder
Naphthalene Sulfonate based superplasticizer—0.20 wt. % based on weight of Portland cement-based binder
Sodium Citrate—0.20 wt. % based on weight of Portland cement-based binder

TABLE 17
Comparative Formulation D
TABLE 17

| Ingredient | Weight % | Volume % |
|---|---|---|
| Portland cement-based binder | 8.6 | 0.9 |
| (cementitious reactive powder)¹ | | |
| Ottawa graded sand | 7.1 | 7.3 |
| Total Liquids² | 4.3 | 1.0 |

¹Portland Cement—100 parts by weight; Fly Ash 30 parts by weight; Land Plaster—3 parts by weight
²Total liquids is a combination of water plus the following chemical additives added to water to form a solution: Polyphosphate—0.20 wt. % based on weight of Portland cement-based binder
Triethanolamine—0.20 wt. % based on weight of Portland cement-based binder
Naphthalene Sulfonate based superplasticizer—0.30 wt. % based on weight of Portland cement-based binder
Sodium Citrate—0.20 wt. % based on weight of Portland cement-based binder

Lab scale panels made with one of the preferred formulation of the invention of TABLE 11 with 4×4 scrim (herein designated formulation A) and compared to lab panels made with the comparison formulations C and D of TABLES 16 and 17 and the same St, Gobain 4×4 scrim.

The results of the comparison of the lab panels A and C and D are shown in TABLE 18.

TABLE 18

| | St. Gobain | St. Gobain | St. Gobain |
|---|---|---|---|
| | 4 × 4 | 4 × 4 | 4 × 4 |
| | formulation A | formulation C | formulation D |
| MOR | 1057 | 1163 | 1251 |
| (psi)- | | | |
| MD | | | |
| only | | | |
| DMAX | 0.781 | 0.809 | 0.539 |
| (in)- | | | |
| MD | | | |
| only | | | |
| Bond- | 17 | 37 | 52 |
| smooth | | | |
| (lb) | | | |
| Bond- | 77 | 61 | 114 |
| rough | | | |
| (lb) | | | |

The test results in TABLE 18, show the panel made from the heavier density formulation D, has a relatively low DMAX, which is not desirable for providing more flexible panels.

Those skilled in the art of cementitious boards, including cement panels, gypsum wallboard, and gypsum fiberboard will recognize that many substitutions and modifications can be made in the foregoing embodiments without departing from the spirit and scope of the present invention.

We claim:

1. A reinforced cementitious board system with improved strength, long term durability and handling properties, comprising:
a core layer of cementitious material having opposed planar surfaces and opposed edges;
at least one outer layer of an alkali resistant fiberglass mesh reinforcement embedded in the opposed planar surfaces of the core layer, and
wherein the fiberglass mesh reinforcement is a mesh scrim having about 4×4 to 6×6 strand per inch construction in the longitudinal and transverse direction, respectively, and,
wherein the fiberglass mesh reinforcement is made from a coated fiberglass yarn, the yarn in an uncoated state has a nominal density of about 1200 to 5000 linear yards per pound of fiberglass yarn, and
the coated yarn comprises 40-65 wt. % coating on a dry basis;
wherein the cementitious material comprises:
25 to 60 wt. %, on a wet basis, cementitious reactive powder comprising Portland cement,
10 to 40 wt. % water,
1 to 70 wt. %, on a wet basis, of filler;
optional additive selected from at least one member of the group consisting of water reducing agents, chemical set-accelerators, chemical set-retarders, air-entraining agents, foaming agents, shrinkage control agents, coloring agents, viscosity modifying agents and thickeners, and internal curing agents; and
wherein the system has improved handling properties compared to prior cement board systems in allowing for deeper penetration and improved bonding of the mesh scrim to the core layer to prevent delamination, and
wherein the cement board system only needs to be scored once on each planar surface to allow for easy snapping of the cement board along the score line during installation of the cement board;
the coating comprising alkali resistant polymer, wherein the yarn comprises 35-60 wt. % of said coating on a dry basis.

2. The system of claim 1, wherein the filler comprises 1 to 10 wt % of an expanded and chemically coated water tight and water repellant perlite filler.

3. The system of claim 1, wherein the cementitious material also comprises about 0 to 50 vol. %, on a wet basis, entrained air.

4. The system of claim 1, wherein the cementitious reactive powder comprises, on a dry basis, about 25 to 100 wt. % Portland cement and 0 to 75 wt. % fly ash based on the sum of the Portland cement and fly ash.

5. The system of claim 1, wherein the filler is a lightweight aggregate or fillers selected from the group consisting of blast furnace slag, volcanic tuff, pumice, sand, expanded clay, expanded shale, expanded perlite, hollow ceramic spheres, hollow plastic spheres, expanded plastic beads, and mixtures thereof.

6. The system of claim 1, wherein the fiberglass yarn, in an uncoated state, has a nominal density of about 3700 to 5000 linear yards per pound of fiberglass yarn.

7. The system of claim 1, wherein the filler are expanded clay and expanded shale.

8. The cementitious board system of claim 1, wherein the mesh scrim is embedded between about 0.03 to about 0.06 inches into at least one of the planar surface of the cement core layer.

9. The cementitious board system of claim 1, wherein the nail pull strength of the cement board system is at least 90 pounds, in accordance with ASTM C-1325-08B.

10. The cementitious board system of claim 1, wherein the density of the cement board is about 40 to 100 pounds per cubic foot.

11. The cementitious board system of claim 1, wherein the density of the cement board is about 50 to 80 pounds per cubic foot.

12. The board system of claim 1, wherein the alkali resistant coating on the
fiberglass fabric is selected from the group consisting of wax, polyvinyl chloride, polyvinyl alcohol, polyvinyl acetate, polyester, acrylics, acrylonitrile, silicones, styrene-butadiene, polypropylene, epoxy and polyethylene, and mixtures thereof.

13. The cementitious board system of claim 1, wherein the board comprises
at least one outer layer of said fiberglass mesh reinforcement on one pair of the opposed edges of the core, and
wherein the fiberglass mesh reinforcement has a 4.0×4.0 strands per inch construction in both the lateral and transverse directions.

14. A method of reinforcing a cementitious board system to provide a cement board with improved strength, nail pull strength and handling properties, comprising providing a core layer of cementitious material, the core layer having opposed planar surfaces and opposed edges, and at least one outer layer of alkali resistant fiberglass mesh scrim reinforcement embedded within the opposed planar surfaces, comprising:
applying a fiberglass mesh scrim to the upper and lower surfaces of a core cementitious slurry by pouring the cementitious slurry through the mesh scrim to coat and embed the entire mesh scrim in the cementitious slurry before the slurry is dried;
wherein the fiberglass mesh scrim has between about 4×4 to about 6×6 strand of fiberglass fiber per inch of the mesh construction in both the longitudinal and transverse directions, respectively, and the fiberglass mesh is made from a coated fiberglass yarn, the yarn in an uncoated state has a nominal density of about 3700 to 5000 linear yards per pound of the fiberglass yarn; and
the coated yarn comprises 40-65 wt. % coating on a dry basis;
wherein. the cementitious material comprises:
25 to 60 wt. %, on a wet basis, cementitious reactive powder comprising Portland cement,
10 to 40 wt. % water,
1 to 70 wt. %, on a wet basis, of filler;
optional additive selected from at least one member of the group consisting of water reducing agents, chemical set-accelerators, chemical set-retarders, air-entraining agents, foaming agents, shrinkage control agents, coloring agents, viscosity modifying agents and thickeners, and internal curing agents; and
the coating comprising alkali resistant polymer, wherein the yarn comprises 35-60 wt. % of said coating on a dry basis.
wherein the system has improved handling properties compared to prior cement board systems in allowing for deeper penetration and improved bonding of the mesh scrim to the core layer to proved a stronger bond between the cementitious core and the mesh scrim to prevent delamination, and
wherein the cement board system only needs to be scored once on each planar surface to allow for easy snapping of the cement board along the score line during installation of the cement board.

15. The method of claim 14, wherein the filler comprises 1 to 10 wt % of an expanded and chemically coated water tight and water repellant perlite filler.

16. The method of claim 14, wherein the cementitious material also comprises about 0 to about 50 vol. %, on a wet basis, entrained air.

17. The method of claim 14, wherein the cementitious reactive powder comprises, on a dry basis, about 25 to 100 wt. % Portland cement and 0 to 75 wt. % fly ash based on the sum of the Portland cement and fly ash.

18. The method of claim 14, wherein the cementitious reactive powder comprises, on a dry basis, about 40 to 80 wt. % Portland cement, 0 to 20 wt.

19. The method of claim 14, wherein the cementitious reactive powder comprises:
35-60 wt. %, on a wet basis, cementitious reactive powder comprising Portland cement and optionally a pozzolanic material,
2-10 wt. %, on a wet basis, expanded and chemically coated water tight and water repellant perlite filler,
20-40 wt. % water,
10-50 vol. %, on a wet basis, entrained air,
optional additive selected from at least one member of the group consisting of water reducing agents, chemical set-accelerators, chemical set-retarders, air-entraining agents, foaming agents, shrinkage control agents, coloring agents, viscosity modifying agents and thickeners, and internal curing agents; and
10-25 wt. % secondary fillers selected from at least one member of the group consisting of expanded clay, shale aggregate, pumice, blast furnace slag, volcanic tuff, sand, expanded shale, expanded perlite, hollow ceramic spheres, hollow plastic spheres, expanded plastic beads, and mixtures thereof;
wherein the total of expanded and chemically coated perlite filler and secondary fillers is at least 20 wt. %.

20. The method of claim 14, wherein at least one outer layer of fiberglass mesh reinforcement is on one pair of the opposed edges of the core, and
wherein the fiberglass mesh scrim has a 4.0×4.0 strands per inch construction in both the lateral and transverse directions, and
wherein the fiberglass mesh is made with a fiberglass yarn, the yarn in an uncoated state has a nominal density of about 3700 linear yards per pound of the fiberglass yarn.

21. The method of claim 14, wherein the fiberglass mesh is made from fiberglass yarn coated with an alkali resistant coating selected from the group consisting of wax, polyvinyl chloride, polyvinyl alcohol, polyvinyl acetate, polyester, acrylics, acrylonitrile, silicones, styrene-butadiene, polypropylene, epoxy and polyethylene and mixtures thereof.
